(19) United States
(12) Patent Application Publication
(10) Pub. No.: US 2026/0354631 A1
(43) Pub. Date: Nov. 12, 2026

(54) STAND-TYPE DRYING DEVICE

(71) Applicant: LG ELECTRONICS INC., Seoul (KR)

(72) Inventors: Sun Min KIM, Seoul (KR); Mu Jin PARK, Seoul (KR); Wonkyu LEE, Seoul (KR); Jihye LEE, Seoul (KR); Chang On LEE, Seoul (KR)

(73) Assignee: LG ELECTRONICS INC., Seoul (KR)

(21) Appl. No.: 19/130,024

(22) PCT Filed: Sep. 19, 2023
(86) PCT No.: PCT/KR2023/014156

§ 371 Date: May 14, 2025

(30) Foreign Application Priority Data
Nov. 14, 2022 (KR) 10-2022-0151595
Nov. 14, 2022 (KR) 10-2022-0151596
Nov. 14, 2022 (KR) 10-2022-0151597
Nov. 14, 2022 (KR) 10-2022-0151598

(51) Int. Cl. A47K 10/48; F26B 21/00; F26B 21/37; F26B 21/55

(52) U.S. Cl. CPC A47K 10/48; F26B 21/001; F26B 21/37; F26B 21/55

(57) ABSTRACT

The present invention relates to a stand-type drying device. The drying device according to the present invention includes a base (10), and a housing (20) may be installed on the base (10). An air blowing unit (30) that causes air to flow is provided inside the housing (20). A discharge column (40), having an air duct (420) through which the airflow generated by the air blowing unit (30) moves, is provided on one side of the housing (20). The discharge column (40) may extend a long distance upward from the housing (20). The discharge column (40) is rod shaped and has a vertically elongated discharge port (418) formed on the front surface, and thus the air blown by the air blowing unit (30) is sprayed and dries the body of a user. The housing (20) may rotate relative to the base (10).

### TECHNICAL FIELD

The present disclosure relates to a stand-type drying device that can be used in an upright position on the floor.

### BACKGROUND ART

People come into contact with various pollutants throughout their lives. For example, when exposed to a dusty environment, the skin may be contaminated with dust. Cooking in the kitchen may cause fumes to come into contact with human skin. Human skin may be contaminated even by sweat, sebum, etc. generated from the human body. To remove such contamination, people wash parts of their bodies or take a shower. Although it varies from person to person, it is common to take a shower every day. In particular, after exercising, it is necessary to take a shower or bath to remove sweat, etc. from the body.

After showering, it is necessary to remove the moisture from your body. Typically, a towel is used to remove the moisture from the body. If the moisture in the body is not removed, there is a problem of creating an environment in which bacteria and fungi can grow. Even if a towel is usually used to remove the moisture from your body, the moisture often remains between the toes, for example, and even in areas that people can't reach, such as the back. In addition, for people with long hair, even if it is thoroughly wiped with a towel, the moisture is not properly removed, so it is required to use a hair dryer.

To solve this problem, a drying device was proposed that sprays air to remove moisture remaining on a person's body after a shower. Prior art document 1, Korean Patent Application Publication No. 10-1996-0000145, discloses a drying device installed on one side of a shower room. This drying device has a step for a user to stand on and is designed to blow air at the head of a user. In particular, multiple exhaust ports are provided on the front surface of the drying device to allow air to be blown onto a user's body. Accordingly, the drying device becomes larger and heavier, so once installed, the drying device is required to be left in place for use, and since the exhaust ports are fixed, there is a problem that air is not delivered to areas far from the exhaust ports, especially areas in the width direction of the body of a user.

Prior art document 2, Korean Patent Application Publication No. 10-2009-0092640, also discloses a drying device that is fixed to a wall. However, because there is a device such as a fan on the upper part of the body of the drying device, the center of gravity is high, so the drying device cannot be placed upright on the floor and is required to be fixed to a wall. Therefore, the drying device of prior art document 2 has the inconvenience of being unable to be moved and used only in a specific location. In addition, the drying device of prior art document 2 has a problem in that a discharge port is located at a position corresponding to the width of the user's body in order to blow air across the width directional entirety of the body of a user, so there is a problem of increasing the overall width of the drying device.

Prior art document 3, Korean Patent Application Publication No. 10-2009-0109364, also discloses a drying device having a similar form to that of prior art document 2. However, the drying device of prior art document 3 also has a high center of gravity, so the drying device cannot be moved and used in a standing form and has a lateral width increasing due to the arrangement of a discharge port.

Prior art document 4, Japanese Patent Application Publication No. 1995-0008412, discloses a drying device in which an air-blowing discharge unit moves up and down. However, according to prior art document 4, since drying is performed only by the discharge unit, drying time is relatively long, and air is discharged from the discharge unit, which has a width corresponding to the width of the body of a user, so the width of the drying device must be at least the same as the width of the body of the user.

Meanwhile, prior art document 5, Korean Patent No. 10-1353571, discloses a portable body dryer. The body dryer in prior art document 5 is configured to blow air toward the upper part of the body of a user starting from the feet of the user when the user stands thereon. However, since the air blown from the body dryer is directed from the lower part of the body of the user to the upper part, there is a problem in that the upper part of the body is not dried properly.

Prior art document 6, Korean Patent No. 10-2420364, discloses a hair dryer that can be fixed in a vertical standing position. Here, the hair dryer is installed on the upper end of a support rod standing upright on a support panel supported on the ground so as to dry the hair of a user. However, the hair dryer of prior art document 6 has a problem in that the hair dryer cannot dry the entire body of a user but can dry only the hair, and a structure for adjusting the angle of the hair dryer relative to the support rod is complex.

### DISCLOSURE

### Technical Problem

The present disclosure is intended to solve the above-mentioned conventional problems, and an objective of the present disclosure is to provide a stand-type drying device that may be used by being placed on the floor while simultaneously blowing air to the entire body of a user from the front surface of the drying device.

An objective of the present disclosure is to have a discharge port that blows air to a user extend long enough to correspond vertically with the entire body of the user.

An objective of the present disclosure is to allow a discharge column having the discharge port that blows air to a user to be rotated at a predetermined angle in the width direction of the user.

An objective of the present disclosure is to place an upper discharge column on the upper side of the discharge column.

An objective of the present disclosure is to enable the upper discharge column on the upper side of the discharge column to rotate up and down at a predetermined angle.

An objective of the present disclosure is to enable the discharge of air around the discharge column together with air provided by an air blowing unit.

An objective of the present disclosure is to blow air uniformly through the discharge port regardless of the location of the discharge column.

An objective of the present disclosure is to enable air surrounding the upper discharge column to be blown together by an airflow formed by the air blowing unit.

An objective of the present disclosure is to separate and direct the flow of air from the air blowing unit in proportion to the volume of an air flow path of an air duct.

An objective of the present disclosure is to install a blowing nozzle in the discharge port of the discharge column or in an upper column discharge port of the upper discharge column to blow air to a user.

An objective of the present disclosure is to place the upper discharge column on the upper side of the discharge column so as to receive air from the discharge column and discharge the air.

An objective of the present disclosure is to automatically control the amount of air blown from the upper discharge column by adjusting the vertical angle of the upper discharge column on the upper side of the discharge column.

An objective of the present disclosure is to provide a joint mechanism connecting the discharge column to the upper discharge column, and to connect an upper air duct of the upper discharge column and the air duct of the discharge column to each other by a connection duct penetrating the joint mechanism.

The objective of the present disclosure is to removably install the upper discharge column on the upper side of the discharge column by using the joint mechanism.

An objective of the present disclosure is to ensure that the upper discharge column rotates accurately relative to the discharge column.

An objective of the present disclosure is to make the upper discharge column separable from the discharge column while the upper discharge column is electrically connected to the discharge column.

An objective of the present disclosure is to enable the precise relative rotation of the upper discharge column relative to the discharge column.

### Technical Solution

In order to achieve the above objectives, in the present disclosure, a discharge column having an elongated discharge port may be installed by extending upward on a housing installed on a base seated on a ground.

In the present disclosure, the discharge column may be extended upward in an elongated shape to simultaneously blow air over the entire body of a user.

In the present disclosure, the discharge column may be rotated at a predetermined angle relative to the base together with the housing installed on the base.

In the present disclosure, an upper discharge column may be installed on an upper portion of the discharge column so as to be rotatable at a predetermined angle by a joint mechanism.

In the present disclosure, the upper discharge column may be rotated up and down relative to the discharge column.

The discharge column of the present disclosure may have a column intake port so that surrounding air may be drawn into the discharge column by an air flow inside the discharge column.

In the present disclosure, an air flow path formed inside the discharge column may have a flow cross-sectional area becoming narrower gradually toward a position away from an air blowing unit, so that the amount of air discharged may be uniform overall.

In the present disclosure, the upper discharge column may also have an upper column intake port to draw surrounding air.

In the present disclosure, the amount of air separated and flowing from an air duct may be determined in proportion to the volume of an air flow path in a direction in which the air flows.

In the present disclosure, a blowing nozzle may be installed in the discharge port of the discharge column or an upper column discharge port of the upper discharge column so as to blow air to a user.

In the present disclosure, the upper discharge column installed on the upper side of the discharge column may receive air from the discharge column and discharge the air to the outside.

In a connection duct of the present disclosure, the amount of air flowing inside may be controlled depending on the degree of rotation of the upper discharge column relative to the discharge column.

In the present disclosure, the discharge column and the upper discharge column may be connected to each other by the joint mechanism, and an upper air duct of the upper discharge column and the air duct of the discharge column may be connected to each other by the connection duct penetrating the joint mechanism.

In the present disclosure, the upper discharge column may be removably installed on the upper side of the discharge column by the joint mechanism.

In the present disclosure, when the upper discharge column rotates relative to the discharge column, the rotation of the upper discharge column may be guided by connectors of the joint mechanism. Therefore, the upper discharge column may be rotated accurately relative to the discharge column.

In the present disclosure, the joint mechanism may have a first electrode and a second electrode, which allow electrical connection between the discharge column and the upper discharge column.

In the present disclosure, a friction pad may be positioned between a female joint and a male joint of the joint mechanism so that the degree of rotation of the upper discharge column relative to the discharge column may be precisely controlled.

A stand-type drying device of the present disclosure may include the base seated on the floor, the housing located on the base and having intake holes, the air blowing unit located inside the housing and allowing air to be drawn in and flow through the intake holes, and the discharge column including the air flow path through which air flowing out of the housing flows, and the discharge port extending vertically, through which air flowing out of the air flow path is discharged to the outside, with the discharge column extending upward from the housing.

In the present disclosure, the upper discharge column may be provided on one side of the discharge column.

In the present disclosure, the upper discharge column may include an upper air blowing unit that may draw in external air and cause the air to flow within the upper discharge column and then be discharged.

In the present disclosure, the discharge column and the upper discharge column may be connected to each other by the joint mechanism so that the upper discharge column can rotate at a predetermined angle relative to the discharge column.

In the present disclosure, the joint mechanism may include the female joint having a recessed shape and the male joint having a hemispherical shape, which is inserted into the female joint, provided at the corresponding positions of the discharge column and the upper discharge column, respectively.

The air blowing unit may include a fan duct installed inside the housing and serving as a passage through which air passes, a motor positioned inside the fan duct, and a fan positioned inside the fan duct and configured to be rotated by the motor to form airflow.

An air guide may be connected to the fan duct to guide air discharged from the fan duct, wherein the air guide may be installed inside the housing and may guide air into the discharge column.

The air duct having the air flow path through which an airflow formed by the air blowing unit passes may be installed inside the discharge column, and a flow outlet may be formed in the air duct in a longitudinal direction thereof to transfer air to the discharge port.

The base may include a base body having a disc shape and a rotation center shaft protruding from a center of the base body and serving as a rotation center of the housing.

A connecting curved surface having a predetermined radius of curvature may be formed on a portion on which the rotation center shaft and the base body are connected to guide air toward the intake holes in the housing.

In the present disclosure, an internal space in which the air blowing unit is positioned may be formed within the housing, a column installation part in which the lower portion of the discharge column is positioned may be formed on one side surface of the housing, and a rotation center hole in which the rotation center shaft of the base is positioned may be provided in the lower portion of the housing.

In the present disclosure, the intake holes through which external air is drawn in by the air blowing unit may be formed on the housing adjacent to the edge of the rotation center hole.

The stand-type drying device of the present disclosure may include the base seated on the floor, with the rotation center shaft protruding from the base, the housing having the rotation center hole into which the rotation center shaft is inserted and the intake holes adjacent to the edge of the rotation center hole, the air blowing unit located inside the housing and allowing air to be drawn in through the intake holes, and the discharge column, which is installed on one side surface of the housing, including the air flow path through which air is moved by the air blowing unit, and the discharge port extending vertically, through which air of the air flow path is discharged to the outside, with the discharge column extending upward from the housing.

In the present disclosure, a driving source configured to provide a driving force for rotating the housing may be installed inside the rotation center shaft of the base.

In the present disclosure, the driving force of the driving source may be transmitted to the housing rotatably installed on the rotation center shaft through multiple gears.

In the present disclosure, the outer surface of the rotation center shaft may have a step part on which the housing is supported, and the rotation center shaft may have a lower outer diameter thereof larger than an upper outer diameter thereof relative to the step part.

In the present disclosure, a support wall surrounding the intake holes formed to be adjacent to the rotation center hole of the housing is provided, and the air blowing unit may be supported on the support wall.

In the present disclosure, the intake holes provided in the housing may be open toward the base, and the base may have the connecting curved surface formed as a curved surface having a predetermined radius of curvature toward the intake holes so as to guide surrounding air to the intake holes.

In the present disclosure, the rotation center shaft may be formed at the center of the base body constituting the base, and a curved surface connecting the rotation center shaft with the base body may be the connecting curved surface.

In the present disclosure, a driving window may be formed on the rotation center shaft to perform power transmission through the multiple gears.

The stand-type drying device of the present disclosure may include the base seated on the floor, the housing located on the base and having the intake holes, the air blowing unit having the fan and the motor to form an airflow and installed inside the housing, and the discharge column formed in a rod shape by extending upward from the housing, and having the discharge port elongated in the vertical direction, with the discharge column configured to discharge air to an area between the left and right sides of the body of a user through the discharge port by rotation of the housing.

In the present disclosure, the air duct having the air flow path through which an airflow formed by the air blowing unit passes may be provided inside the discharge column, and the flow outlet may be formed in the longitudinal direction of the air duct to correspond to the discharge port.

In the present disclosure, the flow cross-sectional area of the air flow path may become narrower gradually in a direction away from the air blowing unit.

In the present disclosure, the base may have the driving source, and the driving force of the driving source may be transmitted through the multiple gears to a driven gear located in the housing to rotate the housing.

The stand-type drying device of the present disclosure may include the base seated on the floor, the housing located on the base and having the intake holes, the air blowing unit located inside the housing and allowing air to be drawn in and flow through the intake holes, and the discharge column including the air duct having the air flow path through which air flowing out of the housing flows, and the discharge port extending vertically, through which air flowing out through the flow outlet of the air duct is discharged to the outside, with the discharge column extending upward from the housing.

In the present disclosure, the flow cross-sectional area of the air flow path may become narrower gradually in a direction away from the air blowing unit.

In the present disclosure, the flow outlet of the air duct may be elongated in the longitudinal direction of the air duct to correspond to the discharge port of the discharge column.

In the present disclosure, the discharge port may be formed on the front surface of a column body constituting the discharge column, and the column intake port through which air around the discharge column is drawn in may be formed on the rear surface of the column body, so that air to be combined with air flowing out of the flow outlet of the air duct and to the discharge port may be drawn in.

In the present disclosure, when viewed in the cross section of the air duct, a flow cross-sectional area may become narrower gradually toward the flow outlet of the air duct.

In the present disclosure, the air duct may have opposite side surfaces inclined toward the flow outlet, so that a front end part of the cross-section of the air duct may be pointed and a rear end part of the cross-section of the air duct may be curved.

In the present disclosure, a filter may be installed on the column intake port.

In the present disclosure, the blowing nozzle may be installed on the discharge port of the discharge column.

In the present disclosure, a blowing flow path through which air flows and is discharged may be formed in the blowing nozzle, and an expansion part may be formed at the end portion of the blowing flow path so that a flow cross-sectional area is relatively large.

The stand-type drying device of the present disclosure may include the base seated on the floor, the housing located on the base and having the intake holes, the air blowing unit located inside the housing and allowing air to be drawn in and flow through the intake holes, and the discharge column including the air duct having the air flow path through which air flowing out of the housing flows by being separated by a separation guide, and the discharge port, through which air flowing out through the flow outlet of the air duct is discharged to the outside, provided by extending in the longitudinal direction thereof, with the discharge column extending upward from the housing, wherein the air flowing in the air flow path may be guided by the separation guide to flow through the upper and lower parts of the air duct.

In the present disclosure, the separation guide may divide air flowing in the air duct in proportion to a ratio of the volume of the air duct above the separation guide to the volume of the air duct below the separation guide.

In the present disclosure, the separation guide may have a central portion protruding sharply and upper and lower portions formed as curved surfaces to divide an airflow, wherein the central portion may be positioned on one side in the height direction of a connection part through which air is introduced into the air duct by the air blowing unit.

In the present disclosure, air separated by the separation guide and flowing to the lower part of the air duct may be delivered to the lower part of the air flow path of the air duct and discharged to the feet of a user through the discharge port of the discharge column.

In the present disclosure, the discharge column may include the column body having the discharge port elongated longitudinally on the front surface thereof, and the air duct having the flow outlet installed inside the column body to deliver air to the discharge port and the connection part receiving air from the air blowing unit.

In the present disclosure, the air flow path inside the air duct may have a flow cross-sectional area becoming narrower gradually in a direction away from the connection part.

In the present disclosure, the air duct may have opposite side surfaces inclined toward the flow outlet, so that the front end part of the cross-section of the air duct may be pointed and the rear end part of the cross-section of the air duct may be curved.

In the present disclosure, the column body may have the column intake port formed on the opposite side of the discharge port so as to draw in air around the discharge column.

In the present disclosure, the column intake port may be provided with the filter configured to filter out foreign substances from air passing therethrough.

In the present disclosure, the upper discharge column may be provided on the upper side of the discharge column so that the upper discharge column is rotated at a predetermined angle relative to the discharge column by the joint mechanism.

In the present disclosure, the upper discharge column may include an upper column body, the upper air blowing unit installed inside the upper column body, and the upper air duct through which an air flow formed by the upper air blowing unit flows.

In the present disclosure, the flow cross-sectional area of the upper air duct may become narrower gradually in a direction away from the upper air blowing unit.

In the present disclosure, the upper discharge column may be used separately from the discharge column.

The stand-type drying device of the present disclosure may include the base seated on the floor, the housing located on the base and having the intake holes, the air blowing unit located inside the housing and allowing air to be drawn in and flow through the intake holes, the discharge column installed on the housing and extending upward, with the discharge column having the discharge port extending longitudinally on the front surface thereof, the upper discharge column installed rotatably at a predetermined angle on the upper side of the discharge column and allowing air delivered through the discharge column to flow and be discharged, and the joint mechanism configured to connect the upper discharge column to the discharge column.

In the present disclosure, the joint mechanism may include the female joint having a recessed shape and the male joint having a hemispherical shape, which is inserted into the female joint, provided at the corresponding positions of the discharge column and the upper discharge column, respectively.

In the present disclosure, a first through-hole may be formed in the female joint, a second through-hole may be formed in the male joint, and the connection duct may be installed by passing through the first through-hole and the second through-hole so as to connect the air duct of the discharge column and the upper air duct of the upper discharge column to each other.

In the present disclosure, the first through-hole and the second through-hole may be formed at misaligned positions so that a communication area therebetween is changed depending on the relative rotation of the female joint and the male joint.

In the present disclosure, the connection duct may be made of a flexible material, and the degree of tightening the connection duct may be changed according to the change of a communication area between the first through-hole and the second through-hole, thereby controlling the flow of air through the connection duct.

In the present disclosure, the discharge column may include the column body, which has a cylindrical shape, having a column internal space formed therein and the discharge port elongated longitudinally on the front surface thereof, and the air duct having the flow outlet installed in the column internal space to deliver air to the discharge port and receiving air from the air blowing unit.

In the present disclosure, the air flow path inside the air duct may have a flow cross-sectional area becoming narrower gradually in a direction away from the air blowing unit.

In the present disclosure, the air duct may have opposite side surfaces inclined toward the flow outlet, so that the front end part of the cross-section of the air duct may be pointed, and the rear end part of the cross-section of the air duct may be curved.

In the present disclosure, the column body may have the column intake port formed on the opposite side of the discharge port so as to draw in air around the discharge column.

In the present disclosure, the column intake port may be provided with a filter to filter out foreign substances from air passing therethrough.

In the present disclosure, the upper discharge column may include a cylindrical upper column body having an upper column internal space formed therein and an upper column discharge port formed to extend longitudinally on a front surface thereof, and an upper air duct having a flow outlet installed in the upper column internal space to deliver air to the upper column discharge port and configured to receive air from an air blowing unit through the air duct of the discharge column and the connection duct penetrating the joint mechanism.

In the present disclosure, the upper air duct may have a flow cross-sectional area becoming narrower gradually in a direction away from the air blowing unit.

The stand-type drying device of the present disclosure may include the base seated on the floor, the housing located on the base and having the intake holes, the air blowing unit located inside the housing and allowing air to be drawn in and flow through the intake holes, the discharge column installed on the housing by extending upward and having the discharge port extending in the longitudinal direction on the front surface thereof so as to discharge air, and the upper discharge column installed rotatably at a predetermined angle on the upper side of the discharge column and allowing air transferred through the discharge column to flow and be discharged through the upper column discharge port, wherein the upper discharge column is rotatable between a state in which the upper discharge column is installed in a straight line relative to the discharge column and a state in which the upper discharge column is rotated at a predetermined angle, and as an angle at which the upper discharge column is inclined relative to the discharge column increases, the amount of air discharged through the upper column discharge port of the upper discharge column may increase.

In the present disclosure, air transfer between the discharge column and the upper discharge column may be performed through the connection duct made of a flexible material.

In the present disclosure, the female joint and the male joint may be respectively formed at corresponding positions in the column body of the discharge column and the upper column body of the upper discharge column, wherein the first through-hole may be formed in the female joint, and the second through-hole may be formed in the male joint. The communication area between the first through-hole and the second through-hole may vary according to the rotated angle of the upper discharge column relative to the discharge column, thereby controlling an air flow through the connection duct.

In the present disclosure, the first through-hole may be formed to be offset to a first side of the female joint, including the center thereof, and the second through-hole may be formed to be offset to a second side of the male joint, including the center thereof.

In the present disclosure, a first stop surface and a second stop surface may be formed on the column body of the discharge column and the upper column body of the upper discharge column, respectively, so as to set a rotational range of the upper discharge column relative to the discharge column.

In the present disclosure, the first stop surface may include a planar part orthogonal to the longitudinal direction of the column body on the end of the column body and an inclined part inclined at a predetermined angle to the longitudinal direction of the column body, and the second stop surface may include a planar part orthogonal to the longitudinal direction of the upper column body on the end portion of the upper column body and an inclined part inclined at a predetermined angle to the longitudinal direction of the column body. The upper discharge column may be operated between a state in which the planar parts are in contact with each other and a state which the inclined parts are in contact with each other.

The stand-type drying device of the present disclosure may include the base seated on the floor, the housing located on the base and having the intake holes, the air blowing unit located inside the housing and allowing air to be drawn in and flow through the intake holes, the discharge column installed in the housing and extending upward so that the discharge port extends longitudinally on the front surface thereof so as to discharge air, and the upper discharge column installed detachably on the discharge column and configured to generate an air flow by the upper air blowing unit installed therein so as to discharge air.

In the present disclosure, the upper discharge column may include the upper column body having the upper column internal space formed therein and the upper column discharge port formed longitudinally on the front surface thereof, and the upper air duct installed in the upper column internal space so that an air flow formed by the upper air blowing unit flows along an upper air flow path formed therein and the flow outlet is formed at a position corresponding to the upper column discharge port.

In the present disclosure, the upper column body may have an upper column intake port formed on the opposite side of the upper column discharge port, and air to be combined with air flowing out of the flow outlet and delivered to the upper column discharge port may be drawn in through the upper column intake port.

In the present disclosure, a filter may be installed in the upper column intake port.

In the present disclosure, the upper air flow path may have a flow cross-sectional area becoming narrower gradually in a direction away from the upper air blowing unit.

In the present disclosure, the discharge column may include the column body having the discharge port formed to extend longitudinally on the front surface thereof, and the air duct having the flow outlet installed inside the column body to transfer air to the discharge port and configured to receive air from the air blowing unit.

In the present disclosure, the air flow path inside the air duct may have a flow cross-sectional area becoming narrower gradually in a direction away from the air blowing unit.

In the present disclosure, the air duct may have opposite side surfaces inclined toward the flow outlet, so that the front end part of the cross-section of the air duct may be pointed and the rear end part of the cross-section of the air duct may be curved, and thus a flow cross-sectional area may become narrower gradually in a direction away from the air blowing unit.

In the present disclosure, the column body may further have the column intake port formed on the opposite side of the discharge port so as to draw in air around the discharge column.

In the present disclosure, the column intake port may be provided with the filter configured to filter out foreign substances from air passing therethrough.

In the present disclosure, the first stop surface and the second stop surface may be formed on the column body of the discharge column and the upper column body of the upper discharge column, respectively, so as to set a rotational range of the upper discharge column relative to the discharge column.

In the present disclosure, the first stop surface may include the planar part orthogonal to the longitudinal direction of the column body on the end of the column body and the inclined part inclined at a predetermined angle to the longitudinal direction of the column body, and the second stop surface may include the planar part orthogonal to the longitudinal direction of the upper column body on the end portion of the upper column body and the inclined part inclined at a predetermined angle to the longitudinal direction of the upper column body, and thus the upper discharge column may be operated between a state in which the planar parts are in contact with each other and a state in which the inclined parts are in contact with each other.

The stand-type drying device of the present disclosure may include the base seated on the floor, the housing located on the base and having the intake holes, the air blowing unit located inside the housing and allowing air to be drawn in and flow through the intake holes, the discharge column that is installed on the housing, extends upward, and has the discharge port extending longitudinally on the front surface thereof to discharge air, the upper discharge column that is installed removably on the discharge column and generates an airflow by the upper air blowing unit installed inside to discharge air, and the joint mechanism that connects the discharge column with the upper discharge column in a removable manner and relatively rotatable manner.

In the present disclosure, the joint mechanism may include a female joint having a recessed shape and a male joint having a hemispherical shape provided at corresponding positions of the discharge column and the upper discharge column, respectively.

In the present disclosure, the female joint may have first connector through-holes formed therethrough, the male joint may have second connector through-holes formed therethrogh at positions corresponding to the first connector through-holes, and thus the connectors installed on the female joint by passing through the first and second connector through-holes may be hooked to the male joint.

In the present disclosure, each of the connectors may include a connector body, a button provided on a first side of the connector body and exposed to a first side of the discharge column, and a holding jaw provided on a second side of the connector body and hooked to a first side of the male joint to serve as a rotation center of the upper discharge column.

In the present disclosure, the button of the connector may be supported by an elastic member having one side supported by the female joint.

The holding jaw may have a guide curved surface formed on a portion of an outer surface thereof, and a guide curved surface by which the guide curved surface of the holding jaw is guided may be formed on a holding jaw guide end formed on an inner side of the male joint.

In the present disclosure, the friction pad may be provided between the inner surface of the female joint and the outer surface of the male joint to provide frictional force during relative rotation between the female joint and the male joint.

In the present disclosure, the first electrode may be installed in the female joint, and the second electrode, which is in contact with the first electrode to be electrically connected thereto, may be positioned in an electrode slot formed in the male joint.

In the present disclosure, the electrode slot may be formed to extend longitudinally in the male joint, so that the second electrode having an arch shape may be positioned in the electrode slot, and the first electrode may be formed in a protrusion shape so as to be in contact with the second electrode while moving relative to the second electrode.

### Advantageous Effects

The stand-type drying device according to the present disclosure may have at least one of the following effects.

The stand-type drying device of the present disclosure may have the housing on the base seated on the ground, and the discharge column of a rod shape extending lengthwise upward from the housing. Accordingly, while the drying device is positioned at a desired location, air may be discharged to the entire body of a user by the discharge column to remove moisture.

In the present disclosure, the discharge column may have a height corresponding to the height of a user, and the discharge port may be formed to extend in the vertical direction of the discharge column so that air may be discharged simultaneously to the entire body of a user to remove moisture.

In the present disclosure, the housing on which the discharge column is installed may rotate by a predetermined angle relative to the base which is seated on the ground. Accordingly, the discharge column may blow air while drawing a circular trajectory with a predetermined radius of curvature according to the rotation of the housing, so that drying may be smoothly performed over the width directional entirety of the body of a user.

In the present disclosure, an upper discharge column may be provided on the upper portion of the discharge column to rotate up and down at a predetermined angle. As air is discharged from the upper discharge column, it is possible to dry the entire body of a user who is taller than average, and to more reliably dry the head area of an average user.

The upper discharge column may rotate up and down at a predetermined angle relative to the discharge column. When the upper discharge column discharges air while inclined at a predetermined angle, the upper portion of the head of a user located below the upper discharge column may be more reliably dried.

In the present disclosure, when air formed by the air blowing unit flows and is blown from the air duct, an airflow may be generated along the outer surface of the air duct by the flow of the blown air, and air around a discharge duct may be drawn in and combined with the air blown from the air duct, so that the combined air may be discharged through the discharge port of the discharge column. Accordingly, the amount of air discharged through the discharge port of the discharge column may be relatively increased.

In the present disclosure, the internal flow cross-sectional area of the air duct inside the discharge column may become narrower gradually in a direction away from the air blowing unit. Therefore, the amount of air discharged through the flow outlet of the air duct may be uniform in the entire flow outlet. This allows air to be discharged evenly in the entire area of the discharge port of the discharge column.

In the present disclosure, when air formed by the upper air blowing unit is blown from the upper air duct in the upper discharge column connected to the upper side of the discharge column, an airflow may be generated along the outer surface of the upper air duct by the flow of the discharged air, and air around an upper discharge duct may be drawn in and combined with the air blown from the upper air duct, so that the combined air may be discharged from the upper column discharge port of the upper discharge column. Accordingly, the amount of air discharged through the upper column discharge port of the upper discharge column may be relatively increased.

In the present disclosure, the blowing nozzle may be installed in the discharge port of the discharge column or the upper column discharge port of the upper discharge column. The blowing nozzle may allow air blown from the discharge port or the upper column discharge port to travel farther while preventing external air from being mixed with air blown from the blowing nozzle.

In the present disclosure, the upper discharge column may be provided on the upper side of the discharge column. In this case, the upper discharge column may receive air through the discharge column and discharge the air. That is, there is no driving source for airflow inside the upper discharge column, and only the air blowing unit in the housing may be used to cause airflow. Therefore, there is the effect that air may be discharged over a larger area without using an additional driving source.

In the present disclosure, the connection duct made of a flexible material may be provided between the discharge column and the upper discharge column. The connection duct may transfers air between the discharge column and the upper discharge column, and the amount of air transferred may be adjusted depending on the rotational position of the upper discharge column relative to the discharge column. Therefore, drying may be performed by changing the amount of discharged air while adjusting the installation angle of the upper discharge column.

In the present disclosure, the discharge column and the upper discharge column may be connected to each other by the joint mechanism so that the discharge column and the upper discharge column are able to rotate relative to each other. The joint mechanism may have the female joint in which the first through-hole is formed and the male joint in which the second through-hole is formed, and the connection duct may be installed by simultaneously penetrating the first through-hole and the second through-hole. The connection duct may vary the amount of airflow through the interior thereof by varying the degree of compression by the female joint and the male joint depending on a communication area between the first through-hole and the second through-hole.

In the present disclosure, the upper discharge column may be removably installed on the discharge column by the joint mechanism. The female joint and the male joint at the corresponding positions of the discharge column and the upper discharge column may be coupled to each other, and at the same time, the holding jaw of the connector on the female joint may be hooked to one side of the male joint, so that the upper discharge column may be more securely mounted on the discharge column.

In the present disclosure, the connector may be further used to couple the female joint to the male joint. The holding jaw in the connector may be hooked to the male joint, and the guide curved surface of the holding jaw may be guided by the guide curved surface of the holding jaw guide end on the male joint side, and accordingly, the rotation of the male joint may occur more smoothly and accurately.

In the present disclosure, the female joint and the male joint may have the first electrode and the second electrode, respectively, and while the second electrode moves relative to the first electrode, the first electrode and the second electrode may always be in contact with each other. Accordingly, when the female joint and the male joint are combined, power connection may be performed through the first electrode and the second electrode, so that power may be efficiently supplied to the upper discharge column.

In the present disclosure, the friction pad may be installed between the female joint and the male joint that constitute the joint mechanism. Frictional force may be generated by the friction pad during relative movement between the female joint and the male joint. Accordingly, the relative movement between the female joint and the male joint may not occur randomly, but rather be caused by a force equal to or greater than a predetermined level, allowing for more precise relative rotation.

### DESCRIPTION OF DRAWINGS

FIG. 1 is a perspective view showing the exterior of a stand-type drying device according to an exemplary embodiment of the present disclosure.

FIG. 2 is a side view showing the configuration of an upper discharge column in an inclined state in the embodiment illustrated in FIG. 1.

FIG. 3 is a vertical sectional view taken in the direction of FIG. 2.

FIG. 4 is a perspective view showing a base, the housing, and a lower portion of a discharge column according to the embodiment of the present disclosure.

FIG. 5 is a sectional perspective view showing the internal configuration of the base and the housing according to the embodiment of the present disclosure.

FIG. 6 is a cross-sectional perspective view showing a configuration for rotating the housing and the discharge column in the embodiment of the present disclosure.

FIG. 7 is a cross-sectional view taken along line 7-7′ of FIG. 2.

FIG. 8 is a perspective view showing the configuration of the base according to the embodiment of the present disclosure.

FIG. 9 is a sectional perspective view showing the housing according to the embodiment of the present disclosure.

FIG. 10 is a perspective view showing an air guide according to the embodiment of the present disclosure.

FIG. 11 is a perspective view showing the discharge column and the upper discharge column according to the embodiment of the present disclosure.

(a), (b), and (c) of FIG. 12 are cross-sectional views taken along lines a-a′, b-b′, and c-c′ of FIG. 3, respectively.

FIG. 13 is a perspective view the air flow path installed inside the discharge column according to the embodiment of the present disclosure.

FIG. 14 is a vertical sectional view showing relative positions between a separation guide and a connection part of the air flow path in the embodiment of the present disclosure.

FIG. 15(a) is a vertical sectional view showing the interior of the upper discharge column according to the embodiment of the present disclosure, and FIG. 15(b) is a perspective view showing an upper air flow path and an upper air blowing unit located inside the upper discharge column.

FIG. 16 is a perspective view showing a joint mechanism for connection and angle adjustment between the discharge column and the upper discharge column in the embodiment of the present disclosure.

FIG. 17 is a sectional perspective view showing the joint mechanism and its surrounding configurations according to the embodiment of the present disclosure.

FIG. 18 is a cross-sectional view showing a blowing nozzle additionally installed at a discharge port of the discharge column in the embodiment of the present disclosure.

FIG. 19 is a vertical sectional view showing a joint mechanism connecting the discharge column with the upper discharge column and a connection duct in another embodiment of the present disclosure.

FIG. 20 is an exploded perspective view of the joint mechanism according to the embodiment illustrated in FIG. 19, with the discharge column mainly shown.

FIG. 21 is an exploded perspective view of the joint mechanism according to the embodiment illustrated in FIG. 19, with the upper discharge column mainly shown.

FIG. 22 is a perspective view showing the configuration of the connection duct used in the embodiment illustrated in FIG. 19.

FIG. 23 is a perspective view showing that the upper discharge column is rotated obliquely relative to the discharge column, and air is delivered from the discharge column to the upper discharge column through the connection duct in the embodiment illustrated in FIG. 19.

FIG. 24 is a partial perspective view showing a joint mechanism connecting the discharge column with the upper discharge column in another embodiment of the present disclosure.

FIG. 25 is a sectional perspective view showing an internal configuration according to the embodiment illustrated in FIG. 24.

FIG. 26 is an exploded perspective view showing the configuration according to the embodiment illustrated in FIG. 24.

FIG. 27 is a front sectional view showing the configuration according to the embodiment illustrated in FIG. 24.

FIG. 28 is an exploded perspective view mainly showing a female joint in the joint mechanism according to the embodiment illustrated in FIG. 24.

FIG. 29 is an exploded perspective view mainly showing a male joint in the joint mechanism according to the embodiment illustrated in FIG. 24.

FIG. 30 is a sectional perspective view showing the internal configuration of the male joint according to the embodiment illustrated in FIG. 24.

FIG. 31 is a perspective view showing a connector used in the embodiment illustrated in FIG. 24.

FIG. 32 is operational state drawings showing that the direction of air discharged from the discharge port of the discharge column changes when the housing rotates at a predetermined angle relative to the base in the embodiment of the present disclosure.

FIG. 33 is an operation state drawing showing the flow of air caused by the operation of an air blowing unit in the embodiment of the present disclosure.

FIG. 34 is an operation state drawing showing that air drawn in by the air blowing unit and air drawn in from a column intake port are combined and discharged from the discharge port in the embodiment of the present disclosure.

FIG. 35 is an operation state drawing showing that air is discharged through a blowing nozzle in the embodiment of the present disclosure.

### BEST MODE

Hereinafter, some embodiments of the present disclosure will be described in detail with exemplary drawings. When adding reference numerals to components in each drawing, it should be noted that identical components are given the same numerals as much as possible even if they are shown in different drawings. In addition, when describing the embodiments of the present disclosure, if it is determined that a detailed description of the related known configuration or function hinders understanding of the embodiments of the present disclosure, the detailed description will be omitted.

The configuration of a stand-type drying device according to an embodiment of the present disclosure will be described in detail with reference to the drawings.

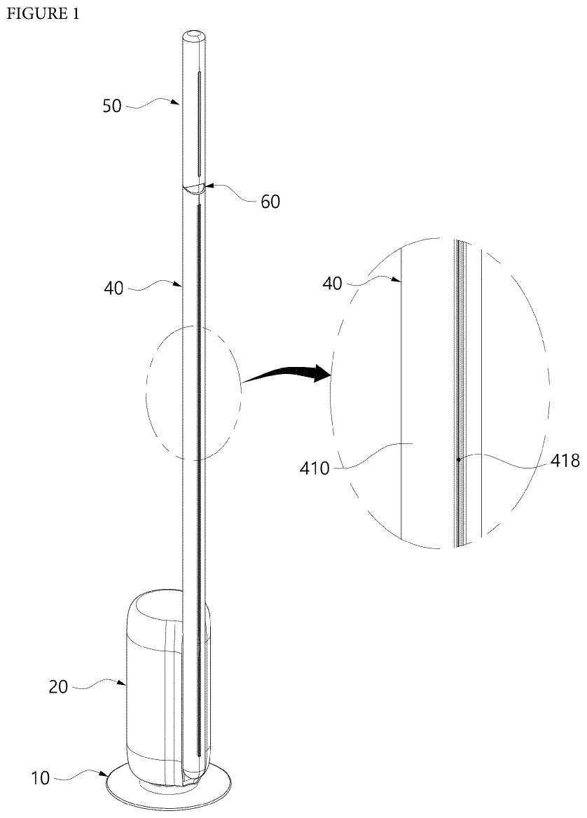

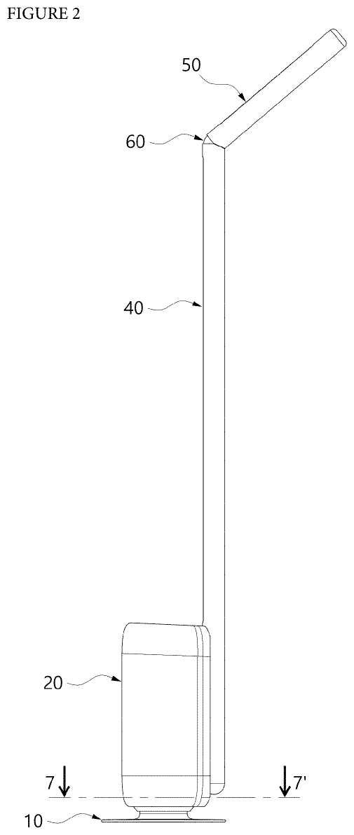

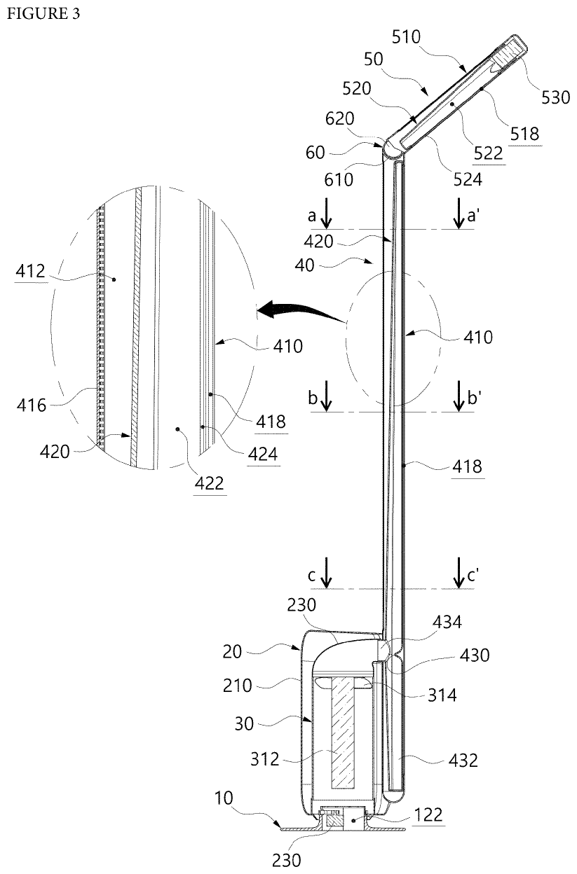

FIGS. 1 and 2 illustrate the overall exterior of the drying device according to embodiment of the present disclosure. According to this, a base 10 maybe seated on the floor, and the housing 20 may be installed on the base 10. An air blowing unit 30 (see FIG. 3) may be provided inside the housing 20. There may be a discharge column 40 coupled to one side of the housing 20 and extending upward from the housing 20. The discharge column 40 may have a discharge port 418 (see FIG. 12) formed in a rod shape to extend in a longitudinal direction. An upper discharge column 50 may be provided on the upper side of the discharge column 40. The upper discharge column 50 may be in a state of FIG. 1 in which it is in a straight line relative to the discharge column 40 and in a state of FIG. 2 in which it has a predetermined angle. To this end, a joint mechanism 60 may be provided between the discharge column 40 and the upper discharge column 50.

For reference, the upper discharge column 50 is not necessarily required. For example, if the head of a user can be sufficiently dried by air discharged from the discharge column 40, the upper discharge column 50 may be omitted. However, the upper discharge column 50 may have an installation angle adjusted, thereby making it relatively convenient to dry the upper portion of the head of a user.

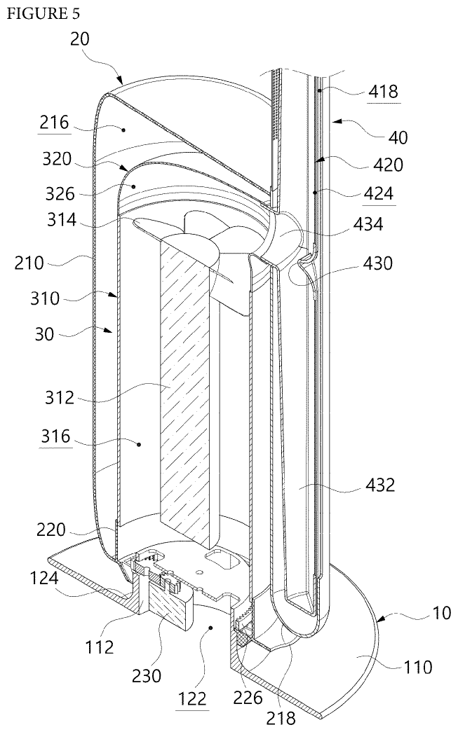

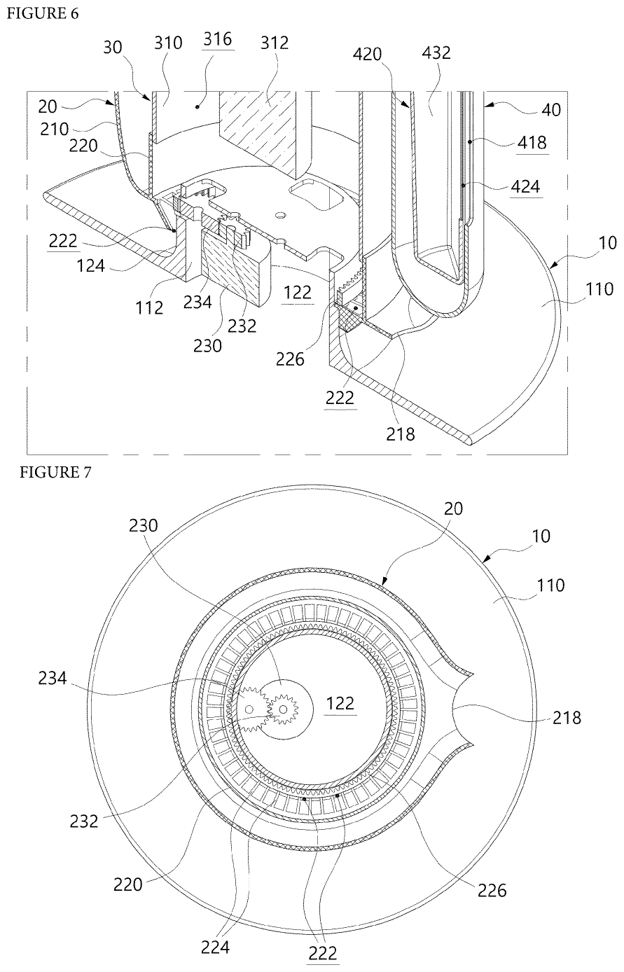

Referring to FIGS. 5 to 8, the base 10 and configurations related thereto will be described. The base 10 may serve to Support the entire device on the ground. The base 10 may directly support the housing 20. Since the discharge column 40 is fixed to the housing 20, it may be considered that the discharge column 40 is indirectly supported by the base 10. Inside the housing 20, there may be the air blowing unit 30, and the air blowing unit 30 may be also indirectly supported by the base 10.

The frame of the base 10 may be constituted by a base body 110. The base body 110 may have an approximately disk-shaped shape. A rotation center shaft 112 may be provided at the center of the base body 110. The rotation center shaft 112 may protrude upward from the upper surface of the base body 110.

The rotation center shaft 112 may be composed of a disc-shaped top plate 114 and a side wall 116 surrounding the edge of the top plate 114 in a ring shape. The rotation center shaft 112 may be the rotation center of the housing 20. The rotation center shaft 112 may have a hollow cylindrical shape. The side wall 116 may have a step part 118. Due to the step part 118, the outer diameter of the lower part of the rotation center shaft 112 may be larger than the outer diameter of the upper part of the rotation center shaft 112. The housing 20 may be rotatably supported on the step part 118.

The side wall 116 may have a driving window 120 provided on one side thereof. The driving window 120 may be configured to transmit the driving force of a driving source 230 to be described below to the housing 20. The driving window 120 may be formed by penetrating the side wall 116. The driving window 120 may be formed on a side with a relatively smaller outer diameter in the side wall 116.

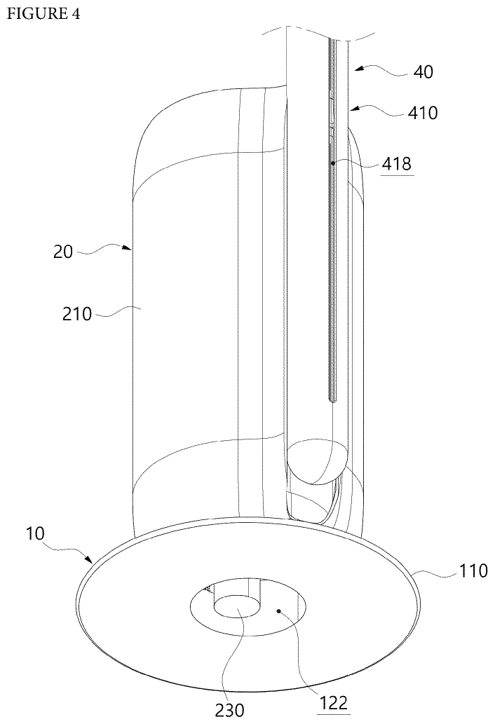

The interior of the rotation center shaft 112 may be a driving source space 122. As illustrated in FIGS. 4 to 6, the driving source space 122 may have a recessed shape when viewed from the bottom of the base 10. The driving source 230 may be installed within the driving source space 122.

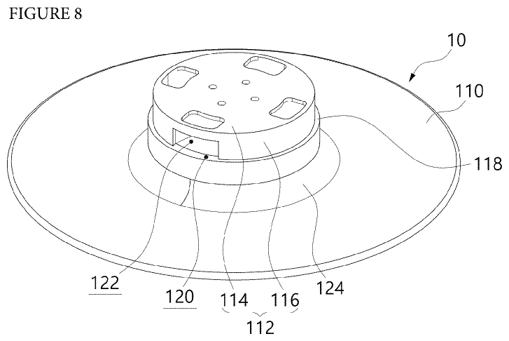

A surface which connects the rotation center shaft 112 with the base body 110 may be a connecting curved surface 124. The connecting curved surface 124 may be a curved surface with a predetermined radius of curvature, as can be seen in FIG. 8. The connecting curved surface 124 may guide air into intake holes 222 of the housing 20, which will be described below.

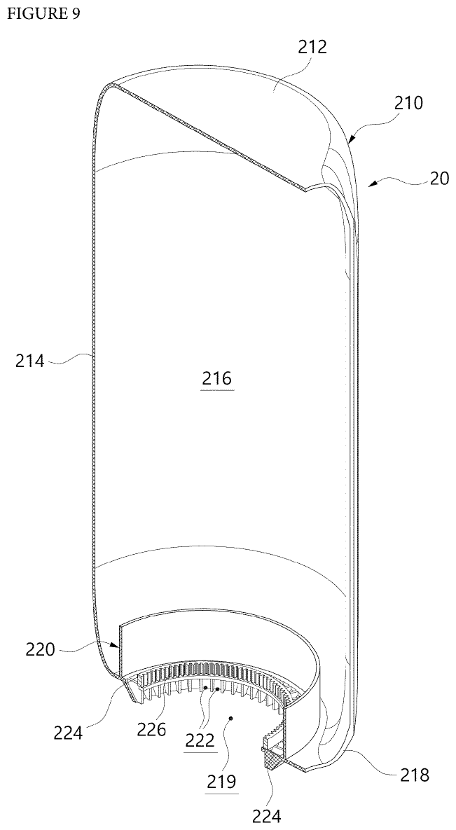

The housing 20 may be installed so as to be rotatable around the rotation center shaft 112 of the base 10. The housing 20 may have a cylindrical shape, as shown in FIGS. 5 and 9. The housing 20, which has a cylindrical shape, may be rotatably installed on the base 10 while in an upright state.

The frame of the housing 20 may be constituted by the housing body 210. The housing body 210, which has a cylindrical shape, may have a disc-shaped end plate 212 on an upper side thereof and have an outer surface constituted by a cylindrical side wall 214. An internal space 216 may be formed inside the housing body 210. The air blowing unit 30 may be installed in the internal space 216.

A column installation part 218 may be formed on one side of the side wall 214 of the housing body 210. In this embodiment, the column installation part 218 may be formed through the side wall 214. However, the column installation part 218 may be formed to be recessed into the side wall 214. The discharge column 40 may be in the column installation part 218. About half of the cross section of the discharge column 40 may be inserted and positioned within the column installation part 218.

The lower part of the housing body 210 may be open. The open portion of the housing body 210 may be a rotation center hole 219. The rotation center shaft 112 of the base 10 may be positioned in the rotation center hole 219. A support wall 220 may be formed in a ring shape around a predetermined distance from the edge of the rotation center hole 219. The drive unit 30 may be supported by the support wall 220.

The intake holes 222 may be formed at positions adjacent to the edge of the rotation center hole 219 on the inner side of the support wall 220. The intake holes 222 may be paths through which outside air is drawn into the air blowing unit 30. The intake holes 222 may be partitioned by multiple partition walls 224. There may be a driven gear 226 to connect the partition walls 224 to each other. The driven gear 226 may be positioned at the edge of the rotation center hole 219. The driven gear 226 may be ring-shaped and have gear teeth formed on an inner surface thereof, so the driven gear 226 may be a type of internal gear. As the partition walls 224 connect the driven gear 226 and the support wall 220 to each other, the intake holes 222 may be formed between the partition walls 224. For reference, as is seen in FIG. 7, the intake holes 222 may be formed to be adjacent to the rotation center shaft 112 of the base 10. Each of the intake holes 222 may be made in the shape of a narrow slit. This is intended to prevent foreign substances from entering the interior through the intake holes 222 from the outside.

A driving force that causes the housing 20 to rotate relative to the base 10 may be provided by the driving source 230. The driving source 230 may be located within the driving source space 122 of the base 20. In the illustrated embodiment, the driving source 230 is simply positioned within the driving source space 122. However, the driving source 230 may be fixed to the base 10 by a bracket, which is not shown.

There may be provided a drive gear 232 rotated by the driving source 230 and an interlocking gear 234 rotated by the drive gear 232. The drive gear 232 and the interlocking gear 234 may be installed on the base 10. The interlocking gear 234 may be coupled to the driven gear 226 to transmit the driving force of the driving source 230. The driving force of the driving source 230 may be directly transmitted to the driven gear 226 by the drive gear 232 without the interlocking gear 234. Alternatively, instead of the interlocking gear 234, multiple gears may be used to reduce speed and transmit a driving force to the housing 20.

Next, the configuration of the air blowing unit 30 is described. The air blowing unit 30 may form airflow so as draw in air from the outside of the housing 20 and discharge the air through the discharge port 418 of the discharge column 40. The air blowing unit 30 may be located inside the internal space 216 of the housing 20. A fan duct 310 may constitute the exterior of the air blowing unit 30. The fan duct 310 may be installed to be supported on the support wall 220. The fan duct 310 may be cylindrical in shape.

A motor 312 and a fan 314 may be installed inside the fan duct 310. While the fan 314 is rotated by the driving force of the motor 312, the fan 314 may form airflow passing through the inside of the fan duct 310. Although a component for fixing the motor 312 is not shown in the drawing, the motor 312 may be supported by a separate bracket or a structure formed in the fan duct 310. The fan 314 may form airflow while being rotated by the motor 312.

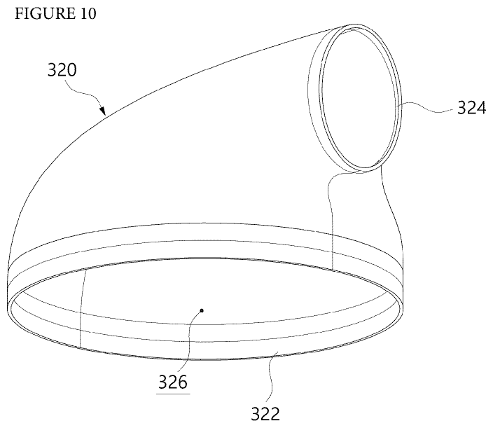

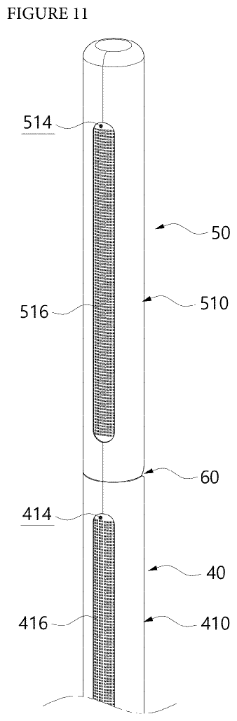

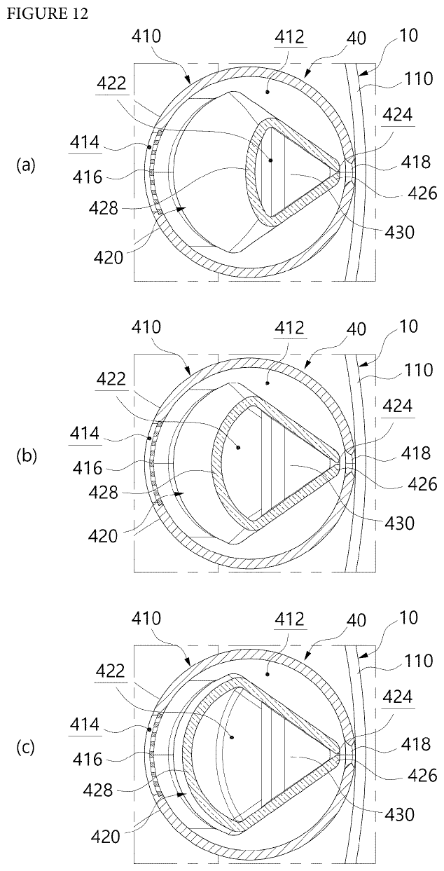

An air guide 320 may be provided to connect the fan duct 310 to an air duct 420 of the discharge column 40, which will be described below. The configuration of the air guide 320 is well illustrated in FIG. 10. The air guide 320 may have a fan duct connection part 322 provided on a first side thereof, and a duct connection part 324 provided on a second side thereof. The fan duct 310 may be connected to the fan duct connection part 322. A connection pipe 434 of the air duct 420 to be described below may be connected to the duct connection part 324. A guide flow path 326 may be formed inside the air guide 320 to guide the flow of air. The guide flow path 326 may have a flow cross-sectional area becoming narrower gradually from the side of the fan duct 310 toward the side of the air duct 420.

The discharge column 40 may be coupled to the housing 20 and may be extended lengthwise upward. The height of the discharge column 40 may be approximately the same as the height of an average user. The discharge column 40 may be shaped like a rod. By making the discharge column 40 rod-shaped, the widthwise size of the entire device may be significantly reduced. The width of the discharge column 40 may be formed to be relatively smaller than that of the housing 20. The width of the discharge column 40 may approximately smaller than one-fourth of the width of the housing 20. Therefore, a space occupied by the discharge column 40 may be much smaller than a space occupied by the housing 20.

The exterior and frame of the discharge column 40 may be constituted by a column body 410. The column body 410 may have an overall cylindrical shape. A column internal space 412 may be formed inside the column body 410. The column internal space 412 may have the same cross-sectional area in the entire section of the column body 410.

A column intake port 414 may be formed in the column body 410. The column intake port 414 may be formed in a section corresponding to the discharge port 418 to be described below. Air around the discharge column 40 may be drawn into the column internal space 412 through the column intake port 414. The column intake port 414 may have a predetermined width. The column intake port 414 may be located in a position at which the column intake port 414 is not visible when a user stands in front of the discharge column 40. That is, the column intake port 414 may be formed on the rear surface of the discharge column 40. A filter 416 may be installed on the column intake port 414. The filter 416 may prevent foreign substances from entering the column internal space 412 through the column intake port 414.

The discharge port 418 may be provided on the front surface of the column body 410. The discharge port 418 may be formed to extend in the vertical direction of the column body 410. Air discharged through the discharge port 418 may be delivered to the body of a user. The discharge port 418 may be shaped like a narrow slit. The width of the discharge port 418 may be formed to be much narrower than the column intake port 414. This allows air to be discharged through the discharge port 418 at a relatively fast speed. Air delivered through the air duct 420, which will be described below, and air drawn in through the column intake port 414 may be combined and discharged through the discharge port 418.

The air duct 420 may be installed in the column internal space 412. The air duct 420 may be a part through which air delivered through the air guide 320 by the air blowing unit 30 flows. The air flow path 422 may be formed inside the air duct 420. Air flowing through the air flow path 422 may be discharged onto the body of a user through the discharge port 418 of the discharge column 40.

The air flow path 422 may have a relatively large flow cross-sectional area at a position closer to the air blowing unit 30, and may have a flow cross-sectional area becoming narrower gradually in a direction away from the air blowing unit 30. This is to ensure that the amount of air discharged through the discharge port 418 is uniform throughout the entire section of the discharge port 418. (a), (b), and (c) of FIG. 12 illustrate cross-sectional shapes at respective locations of the discharge column 40. As can be seen here, the flow cross-sectional area of the air flow path 422 may become narrower gradually toward the upper portion of the air duct 420, or in other words, in a direction away from the air blowing unit 30.

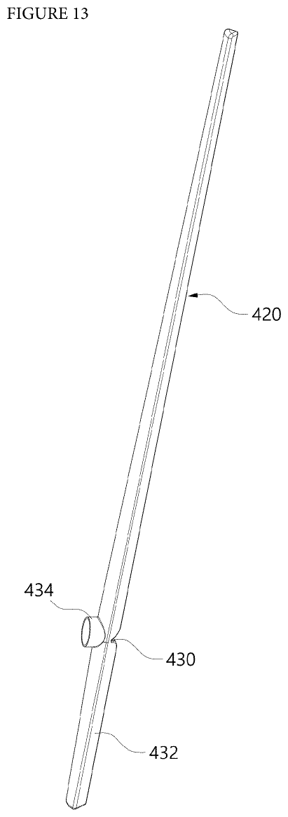

As is seen in FIG. 13, the air duct 420 may have a flow outlet 424. The flow outlet 424 may be a part through which air is discharged from the air duct 420. The flow outlet 424 may be located at a position corresponding to the discharge port 418. That is, the flow outlet 424 may be formed in a slit shape extending in the longitudinal direction of the air duct 420. Therefore, air flowing from the flow outlet 424 may flow directly into the discharge port 418. The flow outlet 424 may be formed in most of the longitudinal section of the air duct 420, as can be seen in FIG. 13.

A portion of the air duct 420 in which the flow outlet 424 is formed is referred to as a front end part 426. A part opposite to the front end part 426, that is, a part of the air duct 420 facing the column intake port 414 of the discharge column 40 is referred to as a rear end part 428. When viewed in the cross section of the air duct 420, the width of the air duct 420 may decrease gradually toward the front end part 426. That is, when the air duct 420 is viewed from the outside, the part in which the flow outlet 424 is formed may be pointed, thereby allowing air to be guided more smoothly through the outer surface of the air duct 420. The rear end part 428 may have a curved surface. The curve surface of the rear end part 428 may facilitate the distribution of air drawn in through the column intake port 414 to opposite sides. This configuration may be seen in FIG. 12.

When air is discharged at a high speed from the flow outlet 424 of the air duct 420, pressure around the front end part 426 of the air duct 420 decreases, causing surrounding air to be drawn in. Therefore, air may be drawn in through the column intake port 414. The air may flow along the curved surface of the rear end part 428 to the opposite sides of the air duct 420, and may flow along the outer surfaces of the opposite sides of the air duct 420 to the front end part 426. The air flowing along the outer surfaces of the air duct 420 may be gathered on opposite sides of air discharged from the flow outlet 424 by the Coanda effect, preventing the air discharged from dispersing, and this air may be discharged through the discharge port 418 of the column duct 40 and delivered to a user. For reference, when the amount of air flowing through the air flow path 422 of the air duct 420 and discharged through the discharge port 418 is sufficient to dry a user, only the air duct 420, without the column intake port 414 provided, may be used to supply air.

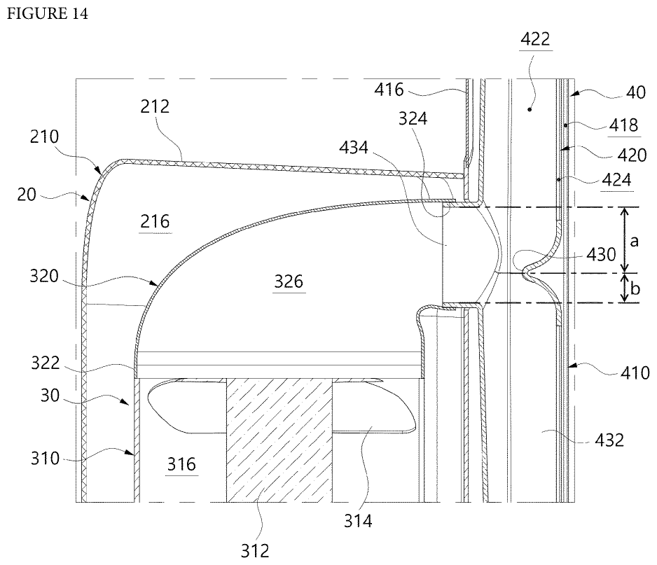

The air duct 420 may include the separation guide 430. The separation guide 430 may protrude to the interior of the air flow path 422. The separation guide 430 may divide air delivered to the air duct 420 and cause the air to flow. The separation guide 430 may allow air which introduced into the air flow path 422 through the duct connection part 324 of the air guide 320 to be divided and moved. The separation guide 430 may have curved surfaces that protrude toward the duct connection part 324 and extend in opposite directions to guide air toward the upper and lower portions of the air flow path 422. The front end part of the separation guide 430 may be located at one-quarter of the height of the duct connection part 324. That is, in FIG. 14, the ratio of a to b may be 3:1. About 25% of air moved by the air blowing unit 30 and entering the air duct 420 may flow to an air flow lower part 432 and be discharged through the discharge port 418 located below the separation guide 430, and about 75% of the air may flow to the upper part of the air duct 420 and be discharged through the discharge port 418 located above the separation guide 430.

The air duct 420 may include the connection pipe 434. The connection pipe 434 may be a part that is connected to the duct connection part 324 of the air guide 320. Accordingly, an airflow formed by the air blowing unit 30 may flow through the air guide 320 to the air flow path 422 inside the air duct 420.

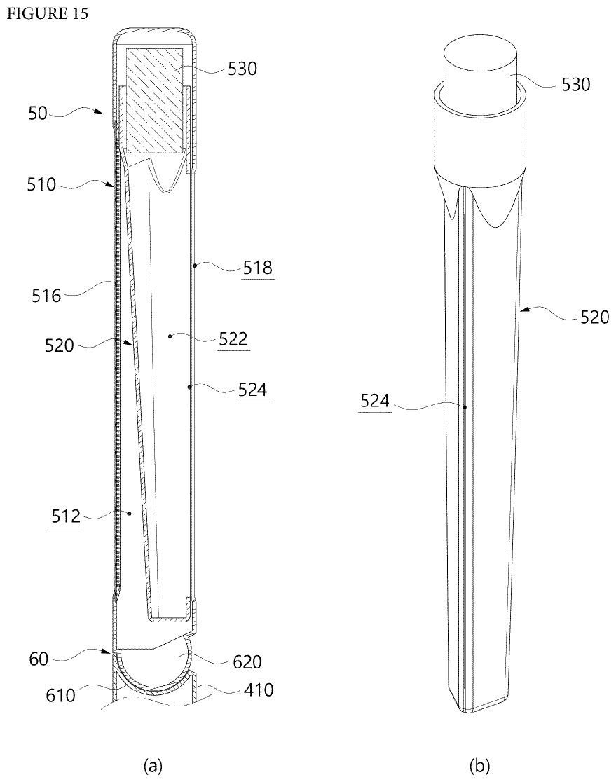

Meanwhile, the upper discharge column 50 may be located on the upper side of the discharge column 40. The configuration of the upper discharge column 50 is well illustrated in FIG. 15(a) and 15(b). The exterior and frame of the upper discharge column 50 may be constituted by an upper column body 510. The upper column body 510 may have a cylindrical shape. An upper column internal space 512 may be formed inside the upper column body 510.

An upper column intake port 514 may be formed on the upper column body 510. Air around the upper discharge column 50 may be drawn in through the upper column intake port 514. A filter 516 may be installed in the upper column intake port 514 to filter out foreign substances in air.

The upper column body 510 may have a discharge port 518. Air may be discharged through the discharge port 518. Air coming out of the discharge port 518 may be discharged to a user to perform a drying function. Air coming out of the discharge port 518 may be discharged mainly on the head of a user. The discharge port 518 may be formed to extend in a slit shape in the longitudinal direction of the upper column body 510.

An upper air duct 520 may be installed within the upper column internal space 512 of the upper column body 510. The upper air duct 520 may have a similar configuration to the air duct 420. The upper air duct 520 may be much shorter than the air duct 420. An upper air flow path 522 within the upper air duct 520 may have a flow cross-sectional area becoming narrower gradually in one direction. That is, the flow cross-sectional area may become narrower gradually in a direction away from an upper air blowing unit 530 to be described below.

The upper air duct 520 may have a flow outlet 524 formed to extend in the longitudinal direction of the upper air duct 520. This is well illustrated in FIG. 15. The shape of the exterior of the upper air duct 520 may be almost identical to the air duct 420. Air coming out through the flow outlet 524 may be discharged to the outside through the discharge port 518 of the upper column body 510.

The upper air blowing unit 530 may be provided on one side of the upper air duct 520. The upper air blowing unit 530 may have a fan and a motor provided therein to draw in outside air and cause the air to flow into the upper air duct 520. The upper air blowing unit 530 may be provided a battery (not shown) and may be operated by using a charged power source. The battery may be charged by being connected to the power source through the discharge column 40, the upper discharge column 50, and the joint mechanism 60. The drawing does not show a configuration in which air may be drawn into the upper air blowing unit 530 from the outside. However, a through-hole may be formed in one end part of the upper column body 510 so that outside air may be drawn into the upper air blowing unit 530.

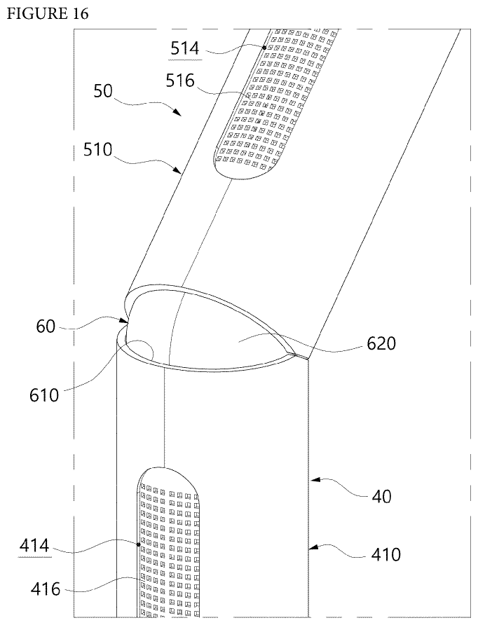

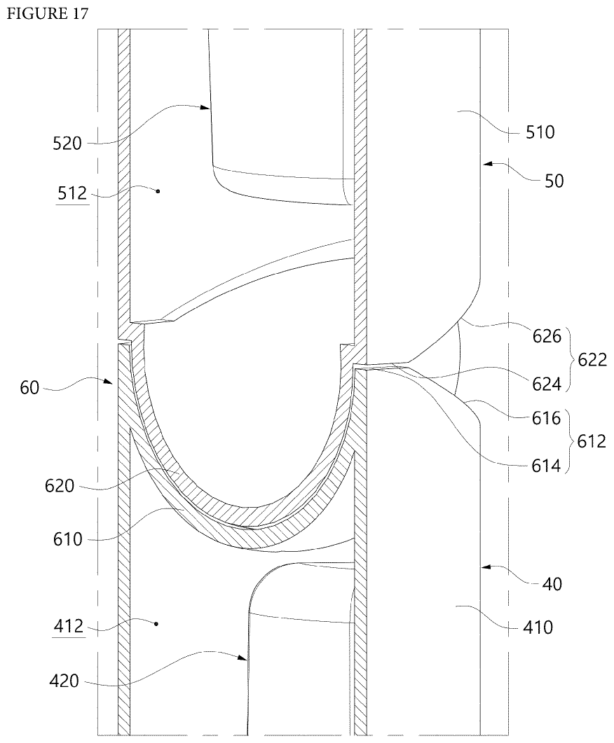

The upper discharge column 50 may be attached to and detached from the discharge column 40. To this end, the discharge column 40 and the upper discharge column 50 may be connected to each other by the joint mechanism 60. The joint mechanism 60 is well illustrated in FIGS. 16 and 17.

In the joint mechanism 60, a female joint 610 on the discharge column 40 and a male joint 620 on the upper discharge column 50 may be coupled to each other to be rotatable relative to each other. The female joint 610 may be formed in a recessed shape in the column body 410. The male joint 620 may be inserted into the female joint 610.

The female joint 610 may be configured as a hemispherical recess. A first stop surface 612 surrounding the edge of the female joint 610 may be provided. The first stop surface 612 may be formed on the end of the column body 410. The first stop surface 612 may include a planar part 614 and an inclined part 616. The planar part 614 may be a part formed orthogonally to the longitudinal direction of the column body 410, and the inclined part 616 may be a part formed to have a predetermined inclination relative to the longitudinal direction of the column body 410.

The male joint 620 may be configured to protrude in a hemispherical shape. The male joint 620 may be inserted into the female joint 610 and may be rotatable relative thereto. The male joint 620 may include a second stop surface 622. The second stop surface 622 may be formed on the end portion of the upper column body 510. The second stop surface 622 may include a planar part 624 and an inclined part 626. The planar part 624 may be a part formed orthogonally to the longitudinal direction of the upper column body 510, and the inclined part 626 may be a part formed to have a predetermined inclination relative to the longitudinal direction of the upper column body 510.

The planar part 614 of the first stop surface 612 may face the planar part 624 of the second stop surface 622, and the inclined part 616 of the first stop surface 612 may face the inclined part 626 of the second stop surface 622. When the discharge column 40 and the upper discharge column 50 are arranged in a straight line, the planar part 614 of the first stop surface 612 and the planar part 624 of the second stop surface 622 may be in contact with each other. (see FIG. 17) When the upper discharge column 50 is rotated to the maximum with respect to the discharge column 40, the inclined part 616 of the first stop surface 612 and the inclined part 626 of the second stop surface 622 may be in contact with each other. (See FIG. 16)

For reference, in the configuration of the joint mechanism 60, the positions of the female joint 610 and the male joint 620 may be reversed from those shown in the illustrated embodiment. The female joint 610 and the male joint 620 may employ components such as a first electrode 850, a second electrode 860, and a friction pad 870 in an embodiment to be described below.

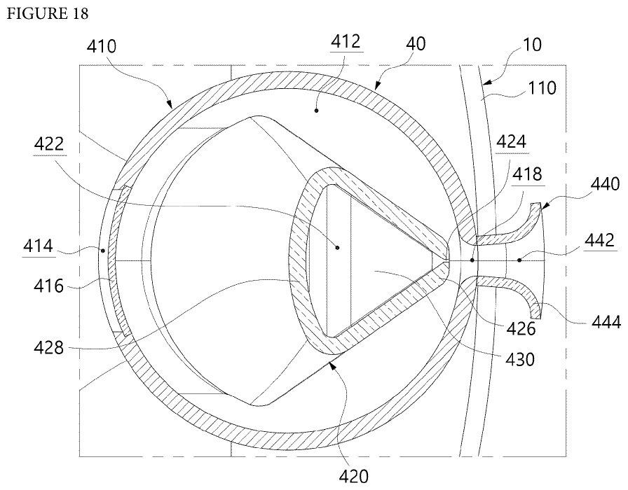

Meanwhile, FIG. 18 illustrates an embodiment in which a blowing nozzle 440 is added to the discharge port 418 of the discharge column 40. The blowing nozzle 440 is configured to blow air passing through the discharge port 418 onto a user. A blowing flow path 422 may be formed through the interior of the blowing nozzle 440. An expansion part 444 may be provided at the front end of the blowing flow path 422. The expansion part 444 may be a portion formed so that a flow cross-sectional area thereof increases abruptly.

In this way, since the blowing nozzle 440 is present and the expansion part 444 is present at the front end of the blowing nozzle 440, air around the discharge port 418 of the discharge column 40 may be prevented from being mixed with air discharged through the blowing nozzle 440. This is because air around the discharge port 418 of the discharge column 40 is guided by the expansion part 444 to be away from the blowing flow path 422. By adding and installing the blowing nozzle 440, unpurified air may be prevented from mixing with air blown through the blowing nozzle 440.

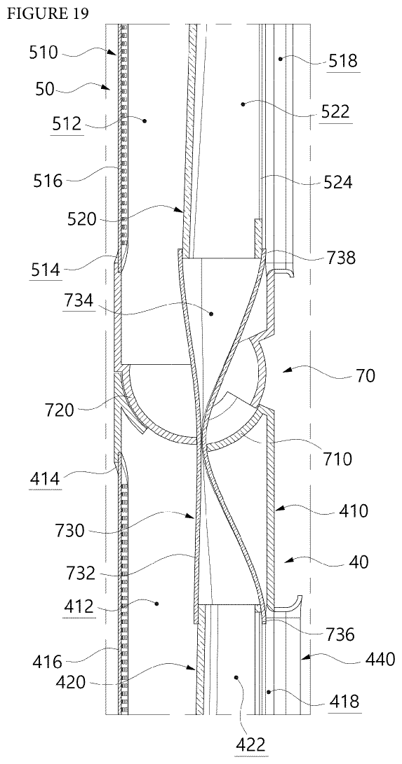

FIG. 19 illustrates another embodiment of the present disclosure. In the embodiment shown here, the upper discharge column 50 located on the upper side of the discharge column 40 receives an air flow formed in the air blowing unit 30 through the air duct 420. Accordingly, in this embodiment, the upper discharge column 50 may not require a separate upper air blowing unit 530, and may not require power supply.

In this embodiment, the discharge column 40 and the upper discharge column 50 may be connected to each other by a joint mechanism 70 so that the discharge column 40 and the upper discharge column 50 are able to rotate relative to each other. The joint mechanism 70 may have a similar configuration to the joint mechanism 60 described in the above embodiment, but a connection duct 730 may extend through the joint mechanism 70 to connect the air duct 420 of the discharge column 40 with the upper air duct 520 of the upper discharge column 50 to cause an air flow.

In the joint mechanism 70, a female joint 710 on the side of the discharge column 40 and a male joint 720 on the side of the upper discharge column 50 may be coupled to each other to be rotatable relative to each other. The female joint 710 may be formed in a recessed shape in the column body 410. The male joint 720 may be inserted into the female joint 710.

The female joint 710 may be configured as a hemispherical recess. The female joint 710 may include a first stop surface 712. The first stop surface 712 may be the end portion of the column body 410. The first stop surface 712 may include a planar part 714 and an inclined part 716. The planar part 714 may be a part formed orthogonally to the longitudinal direction of the column body 410, and the inclined part 716 may be a part formed to have a predetermined inclination relative to the longitudinal direction of the column body 410.

A first through-hole 718 may be formed on one side of the female joint 710. The first through-hole 718 may be formed through the female joint 710. Accordingly, the column internal space 412 and the interior of the female joint 710 may communicate with each other by the first through-hole 718. The connection duct 730, which will be described below, may pass through the first through-hole 718. The first through-hole 718 may be formed to be offset to the one side of the female joint 710, including the center thereof. This is to allow the area of communication thereof with a second through-hole 728, which will be described below, to be varied depending on a degree to which the upper discharge column 50 is rotated relative to the discharge column 40.

The male joint 720 may protrude to have a hemispherical shape. The male joint 720 may be inserted into the female joint 710 and may be rotatable relative thereto. The male joint 720 may include a second stop surface 722. The second stop surface 722 may be the end portion of the upper column body 510. The second stop surface 722 may include a planar part 724 and an inclined part 726. The planar part 724 may be a part formed orthogonally to the longitudinal direction of the upper column body 510, and the inclined part 726 may be a part formed to have a predetermined inclination relative to the longitudinal direction of the upper column body 510.

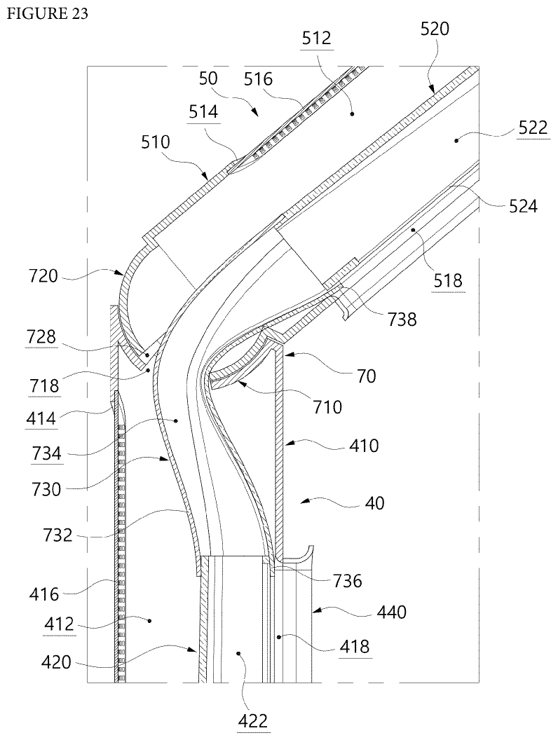

The planar part 714 of the first stop surface 712 may face the planar part 724 of the second stop surface 722, and the inclined part 716 of the first stop surface 712 may face the inclined part 726 of the second stop surface 722. When the discharge column 40 and the upper discharge column 50 are arranged in a straight line, the planar part 714 of the first stop surface 712 and the planar part 724 of the second stop surface 722 may be in contact with each other. (see FIG. 19) When the upper discharge column 50 is rotated to the maximum with respect to the discharge column 40, the inclined part 716 of the first stop surface 712 and the inclined part 726 of the second stop surface 722 are in contact with each other. (See FIG. 23)

A second through-hole 728 may be formed on a first side of the male joint 720. The upper column internal space 512 may be connected to the outside by the second through-hole 728. The connection duct 30 may be extended through the second through-hole 728. The location at which the second through-hole 728 is formed may be offset to a second side of the male joint 720, including the center thereof. That is, when the discharge column 40 and the upper discharge column 50 are arranged in a straight line, an area in which the first through-hole 718 and the second through-hole 728 overlap and communicate with each other may be the narrowest (see FIG. 19), and when the upper discharge column 50 is rotated and arranged to be inclined with respect to the discharge column 40, an area in which the first through-hole 718 and the second through-hole 728 overlap and communicate with each other may be the widest (see FIG. 23).

As can be seen in FIG. 19, in this embodiment, the air duct 420 and the upper air duct 520 may be connected with each other by the connection duct 730. Accordingly, air flowing within the air duct 420 may be delivered to the upper air duct 520 via the connection duct 730. The connection duct 730 may be made of flexible material. The connection duct 730 may be free to bend and may be pressed by an external force, so that the internal flow cross-sectional area may be adjusted.

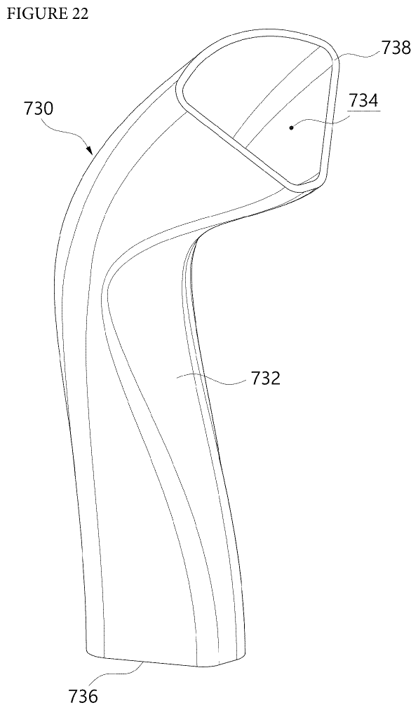

The configuration of the connection duct 730 is well illustrated in FIG. 22, where a connection duct body 732 may constitute the exterior and frame thereof. The connection duct body 732 may be made of a flexible material and have a connecting flow path 734 formed therethrough. Air may flow through the connecting flow path 734. An air duct connection part 736 connected to the air duct 420 may be provided on a first end of the connection duct body 732, and an upper air duct connection part 738 connected to the upper air duct 520 may be provided on a second end of the connection duct body 732. The air duct connection part 736 may have a shape corresponding to the shape of the air duct 420 coupled thereto, and the upper air duct connection part 738 may have a shape corresponding to the shape of the upper air duct 520 coupled thereto.

As can be seen in FIG. 19, when a communication area between the first through-hole 718 and the second through-hole 728 through which the connection duct 730 passes at the same time is the smallest, the connection duct 730 may be pressed by the edges of the first through-hole 718 and the second through-hole 728, thereby narrowing or closing the internal flow cross-sectional area of the connection duct 730. In this state, no or little air may be delivered to the upper air duct 520 through the connection duct 730. The amount of air flowing through the connection duct 730 may be determined depending on the size of the overlapping area between the first through-hole 718 and the second through-hole 728.

Meanwhile, as can be seen in FIG. 23, when the communication area between the first through-hole 718 and the second through-hole 728 is the largest, no external force may be applied to the connection duct 730, so the flow cross-sectional area of the connecting flow path 734 may be maintained to be the largest. Accordingly, the largest amount of air may be delivered to the upper air duct 520 through the connecting flow path 734. When the inclination of the upper discharge column 50 is adjusted so that the upper discharge column 50 is at a position between FIGS. 19 and 23 with respect to the discharge column 40, the amount of air discharged through the upper discharge column 50 may be adjusted. When the upper discharge column 50 is rotated to the maximum with respect to the discharge column 40, the amount of air discharged through the upper discharge column 50 may be the largest. Accordingly, the head a user and the surrounding area may be dried better.

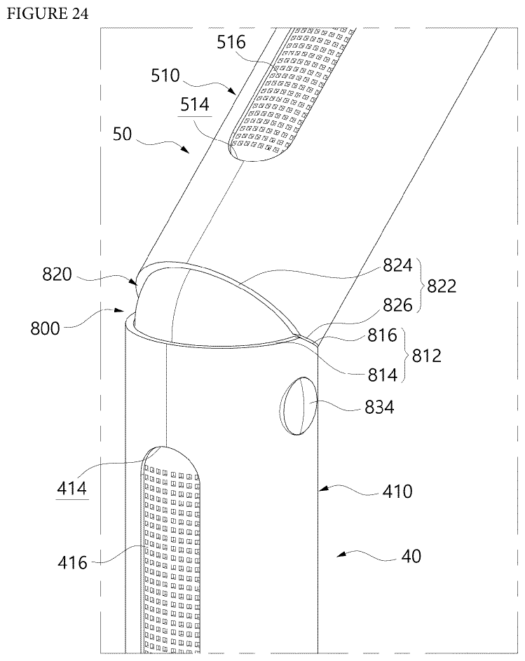

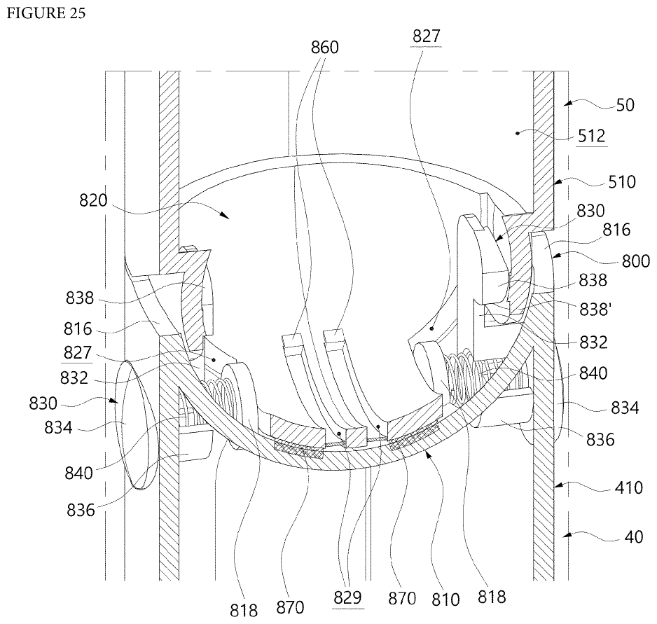

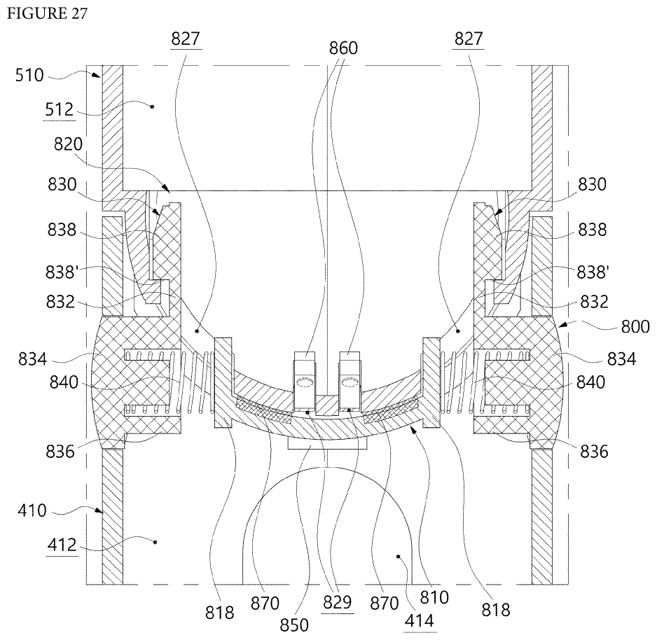

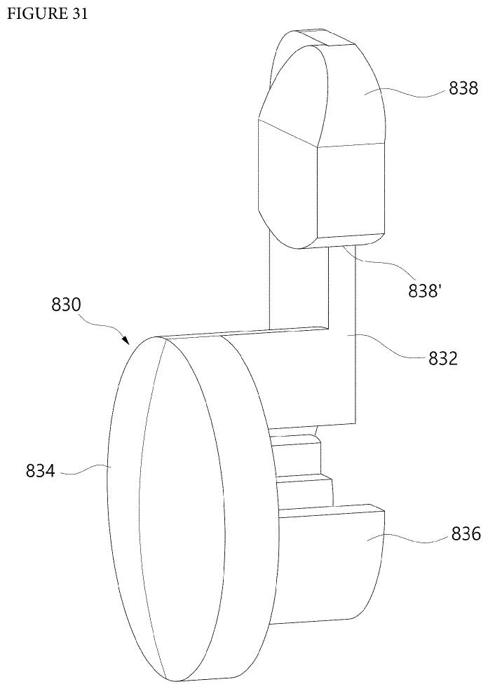

Another embodiment is illustrated in FIGS. 24 to 31. Here, the upper discharge column 50 may be detachably connected to the discharge column 40 by a joint mechanism 80. The joint mechanism 80 enables power connection, thereby supplying power to the upper air blowing unit 530 located inside the upper discharge column 50. It is also possible to charge a battery (not shown) in the upper air blowing unit 530, so that the upper discharge column 50 may be used separately from the discharge column 40. In this case, the upper discharge column 50 may be held by the hand of a user and used to dry various parts of the body.

In this embodiment, the upper discharge column 50 may be detachable from the discharge column 40. For this purpose, the joint mechanism 80 may have connectors 830, and by pressing buttons 834 of the connectors 830 and adjusting the position of each of the connectors 830, the upper discharge column 50 may be mounted on and detached from the discharge column 40.

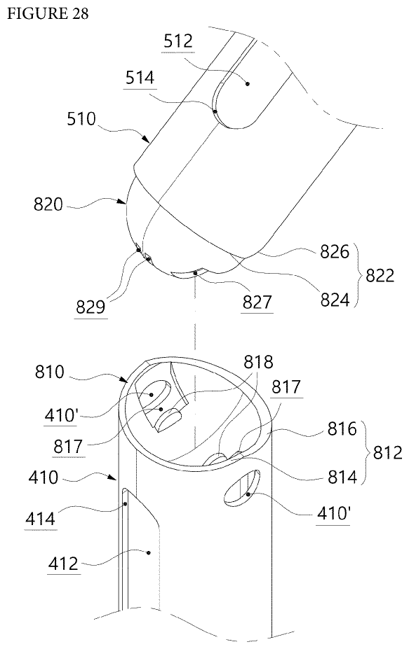

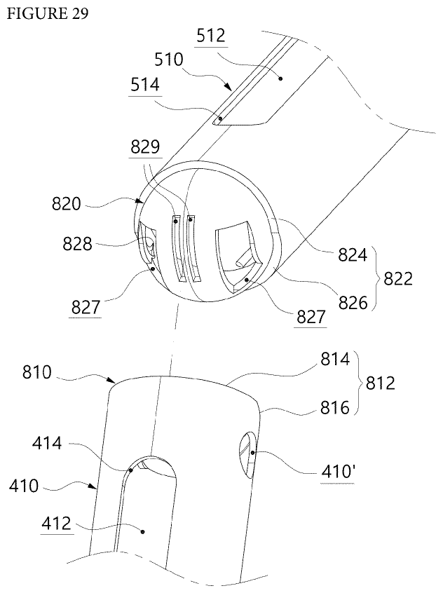

In the joint mechanism 80, a female joint 810 (see FIG. 28) on the discharge column 40 and a male joint 820 (see FIG. 29) on the upper discharge column 50 may be coupled to each other to be rotatable relative to each other. The female joint 810 may be formed in a recessed shape in the column body 410. The male joint 820 may be inserted into the female joint 810.

The female joint 810 may be configured as a hemispherical recess. The female joint 810 may have a first stop surface 812. The first stop surface 812 may be the end portion of the column body 410. The first stop surface 812 may include a planar part 814 and the inclined part 816. The planar part 814 may be a part formed orthogonally to the longitudinal direction of the column body 410, and the inclined part 816 may be a part formed to have a predetermined inclination relative to the longitudinal direction of the column body 410.

The female joint 810 may have first connector through-holes 817 formed through opposite sides thereof. A button holes 410′ may be formed at each of positions of the column body 410 corresponding to the first connector through-holes 817. The connectors 830 may be installed by passing through the first connector through-holes 817.

A support plate 818 may be provided on the inner side of the female joint 810 corresponding to one edge of the first connector through-hole 817. The support plate 818 may be a part on which one side of an elastic member 840, which will be described below, is supported. The support plate 818 may face the button hole 410′.

The male joint 820 may protrude to have a hemispherical shape. The male joint 820 may be inserted into the female joint 810 and be rotatable relative thereto. The male joint 820 may include a second stop surface 822. The second stop surface 822 may be the end portion of the upper column body 510. The second stop surface 822 may include a planar part 824 and an inclined part 826. The planar part 824 may be a part formed orthogonally to the longitudinal direction of the upper column body 510, and the above inclined part 826 may be a part formed to have a predetermined inclination relative to the longitudinal direction of the upper column body 510.

The planar part 814 of the first stop surface 812 may face the planar part 824 of the second stop surface 822, and the inclined part 816 of the first stop surface 812 may face the inclined part 826 of the second stop surface 822. When the discharge column 40 and the upper discharge column 50 are arranged in a straight line, the planar part 814 of the first stop surface 812 and the planar part 824 of the second stop surface 822 may be in contact with each other.

When the upper discharge column 50 is rotated to the maximum with respect to the discharge column 40, the inclined part 816 of the first stop surface 812 and the inclined part 826 of the second stop surface 822 may be in contact with each other. (See FIG. 24)

As well illustrated in FIG. 29, the male joint 820 may have second connector through-holes formed through opposite sides thereof. The second connector through-holes may be formed at positions corresponding to the first connector through-holes 817. Each of the second connector through-holes may be formed to have a relatively longer length in one direction compared to each of the first connector through-holes 817. This is to prevent the connector 830 and the male joint 820 from interfering with each other when the upper discharge column 50 rotates relative to the discharge column 40.

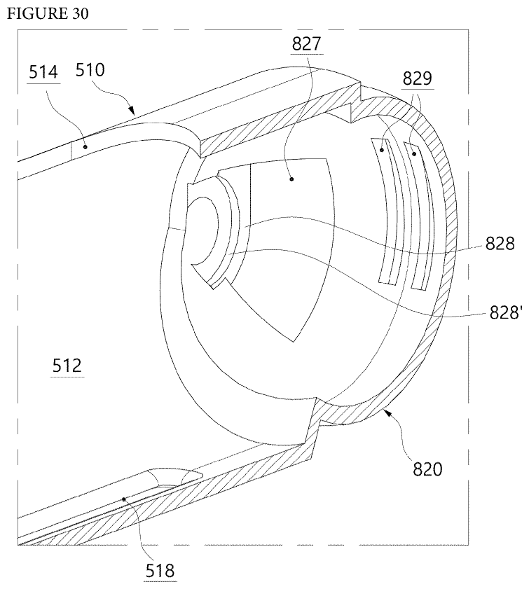

A holding jaw guide end 828 may be provided inside the male joint 820. The holding jaw guide end 828 is well illustrated in FIGS. 29 and 30. The holding jaw guide end 828 may be a part to which a holding jaw 838 of the connector 830 is hooked. The holding jaw guide end 828 may have a guide curved surface 828′ formed to have a predetermined radius of curvature. The outer surface of the holding jaw 838 of the connector 830 may be in contact with the guide curved surface 828′, wherein the holding jaw 838 may be the center of rotation of the upper discharge column 50.

An electrode slot 829 may be formed along the widthwise central position of the male joint 820. The electrode slot 829 may extend longitudinally in the rotational direction of the upper discharge column 50. In this embodiment, the electrode slot 829 may include two electrode slots 829 formed side by side. Electrical contact between the first electrode 850 and the second electrode 860, which will be described below, may be performed through the electrode slots 829.

The connector 830 allows the upper discharge column 50 to be mounted on the discharge column 40 so that the upper discharge column 50 is rotatable relative to the discharge column 40. The connector 830 may be installed on the female joint 810 and hook the male joint 820 to be rotatable. A connector body 832 may constitute the frame of the connector 830. The button 834 may be provided on a first side of the connector body 832. The button 834 may be exposed to the outside of the discharge column 40 through the button hole 410′.

The connector body 832 may have an elastic member support end 836. The elastic member support end 836 may be located on the opposite side of the outer surface of the button 834. The elastic member support end 836 may allow one side of the elastic member 840 to be fitted therein so that the elastic member 840 is supported. For example, the elastic member support end 836 may be formed in a cylindrical shape and have a guide pin 837 therein that guides elastic deformation of the elastic member 840. The guide pin 837 may be inserted into the elastic member 840.

The holding jaw 838 may be provided on a second side of the connector body 832. The holding jaw 838 may be formed on the second side of the connector body 832 at a predetermined distance from the position at which the button 834 is formed. The holding jaw 838 may have a portion having the shape of a disk. A guide curved surface 838′ may be formed on a portion of the outer surface of the holding jaw 838. The guide curved surface 838′ may be a part guided by the guide curved surface 828′ of the holding jaw guide end 828.

The connector 830 having this configuration may include a pair of two connectors. The button 834 of each of the connectors 830 may be positioned within the button hole 410′ open at each of the opposite sides of the column body 410 of the discharge column 40. When the connector 830 is installed in the female joint 820, the connector 830 may receive the elastic force of the elastic member 840. The elastic force of the elastic member 840 may cause the button 834 to tend to protrude to the outside of the button hole 410′. The elastic member 840 may use a cylindrical coil spring, a first end part of which is inserted and supported within the elastic member support end 836 of the connector 830. A second end part of the elastic member 840 may be supported on the support plate 818 of the female joint 810. Accordingly, when a user presses the button 834, the connector 830 may be moved while compressing the elastic member 840, so that the button 834 may move a predetermined distance into the button hole 410′.

The elastic member 840 may provide elastic force to the connector 830. The connector 830 may be installed in a state in which the connector 830 is supported by the elastic member 840 in the female joint 810, and the connector 830 may be hooked to the holding jaw guide end 828 of the male joint 810 so that the upper discharge column 50 may be maintained to be rotatably hooked to the discharge column 40. When a user presses the button 834 of the connector 830, the button 834 may move into the button hole 410′ and the holding jaw 838 may come out of the holding jaw guide end 828. In this state, the upper discharge column 50 may be separated from the discharge column 40.

The first electrode 850 may be installed on the female joint 810. The first electrode 850 may be connected to the power source supplied to the drying device of the present disclosure. The first electrode 850 may have a protrusion-shaped configuration so that the first electrode 850 may be in contact with the second electrode 860 inside the electrode slot 829. The second electrode 860 may be installed on the male joint 820. The second electrode 860 may be configured to extend longitudinally to correspond to the shape of the electrode slot 829. The second electrode 860 may be configured in an arch shape with a predetermined radius of curvature. A position at which the first electrode 850 is in contact with the second electrode 860 may vary depending on a degree to which the upper discharge column 50 is rotated. When the upper discharge column 50 rotates relative to the discharge column 40, the first electrode 850 may be in contact with the second electrode 860, and the contact position of the first electrode 850 with the second electrode 860 may change. In reality, the first electrode 850 may be fixed, and the second electrode 860 may be moved while rotating together with the rotation of the male joint 820.

There may be the friction pad 870 between the inner surface of the female joint 810 and the outer surface of the male joint 820. The friction pad 870 may provide friction to prevent arbitrary relative movement between the male joint 820 and the female joint 810. The friction pad 870 may be fixed to the female joint 810 or the male joint 820 and provide frictional force to the counterpart, the male joint 820 or the female joint 810.

Hereinafter, the operation of the stand-type drying device having the configuration described above according to an embodiment of the present disclosure will be described in detail.

The stand-type drying device of the present disclosure, as can be seen in FIGS. 1 to 3, may have the air blowing unit 30 positioned within the housing 20 rotatably supported on the base 10, and the discharge column 40 in a rod shape extending upward from the housing 20. Air may be blown to a user through the discharge port 418 of the discharge column 40, and as the housing 20 rotates relative to the base 10, the discharge column 40 may rotate at a predetermined angle to blow air over a predetermined range in the width direction of the body of the user to perform drying.

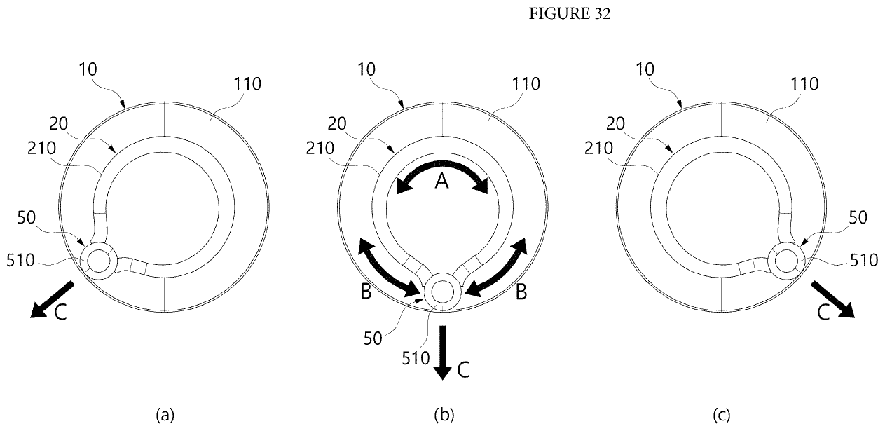

That is, the discharge column 40 may perform drying by blowing air in the width direction of the body of a user while rotating left and right relative to the user. The user may stand in front of the discharge column 40 and perform the drying process while being exposed to the blown air. After the user stands facing the discharge column 40 and drying is performed on the front side of the body, the user may turn around and perform drying on the back side of the body of the user by making the back side of the body of the user face the discharge column 40. In FIG. 32(a), 32(b), and 32(c), it is shown that the housing 20 is rotated (in the direction of arrow A) relative to the base 10, and the position of the discharge column 40 is moved (in the direction of arrow B) as a result. Alternatively, it is shown that air is discharged from the discharge port 418 of the discharge column 40 (arrow C).

In this case, the discharge port 418 formed in the discharge column 40 may simultaneously dry the feet of a user to a position corresponding to the lower portion of the housing 20. In addition, in the case in which the upper discharge column 50 is located on the discharge column 40, air blown from the upper discharge column 50 may dry the head of a user. In particular, when the upper discharge column 50 is inclined at a predetermined angle relative to the discharge column 40, air may be blown from the upper side of the head of a user, thereby enabling better drying of the head area.

Meanwhile, in the stand-type drying device of the present disclosure, the housing 20 and the air blowing unit 30 may be located on the base 10 seated on the floor, and the discharge column 40 extending from the housing 20 may extend upward in a rod shape with a relatively small diameter, so that the center of gravity of the device as a whole may be located at a position adjacent to the base 10. Therefore, the stand-type drying device of the present disclosure may be stably seated on the floor and may be light in weight overall, so that a user may easily move the device and perform drying at a desired location. Although not shown in the drawing, when there is a handle on one side of the base 10 or a handle connected simultaneously to the base 10 and the housing 20, the stand-type drying device of the present disclosure may be moved more easily.

For example, after performing basic drying by placing the stand-type drying device in a shower room, the stand-type drying device may be moved to the living room, etc. to perform more detailed drying. For example, while sitting on a chair, drying of the head may be performed by inclining the upper discharge column 50, and drying of the feet may be performed by air coming out of the discharge port 418 corresponding to the air flow lower part 432.

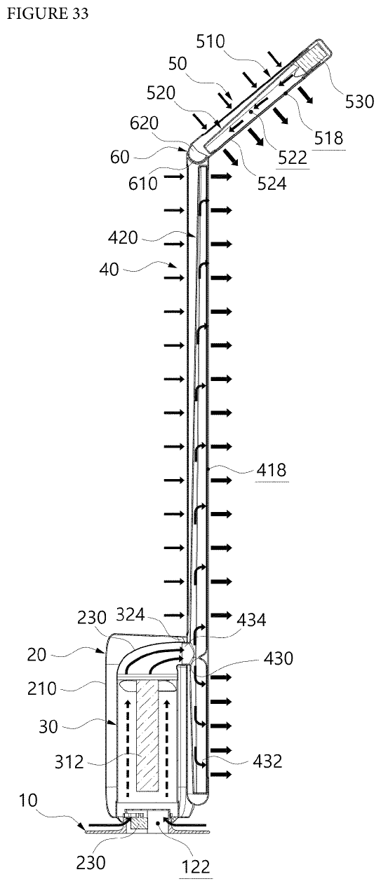

The flow of air in the stand-type drying device of the present disclosure will be described with reference to FIG. 33. When a user turns on the drying device, the air blowing unit 30 may be operated. The motor 312 of the air blowing unit 30 may operate to rotate the fan 314, thereby creating an airflow within the fan duct 310. Accordingly, outside air may be drawn into the interior through the intake holes 222. Air surrounding the base 10 may be drawn into the intake holes 222, and the connecting curved surface 124 may play a role in allowing the air to flow more smoothly into the intake holes 222.

The air drawn through the intake holes 222 may flow into the fan duct 310, pass through the fan duct 310 by the driving of the fan 314, and flow into the guide flow path 326 inside the air guide 320. The air may flow into the air duct 420 of the discharge column 40 through the connection pipe 434 connected to the duct connection part 324, which is the exit of the guide flow path 326.

When air flows into the air duct 420 through the connection pipe 434, the flowing air may be divided by the separation guide 430. Due to the separation guide 430, some of the air may flow to the air flow lower part 432, and the remaining air may flow to the air flow path 422 of the air duct 420 located at the upper portion of the discharge column 40.

The air duct 420 is designed such that a flow cross-sectional area thereof becomes narrower gradually in a direction away from the separation guide 430. Accordingly, the discharge port 418 may discharge a uniform amount of air in the entire section thereof.

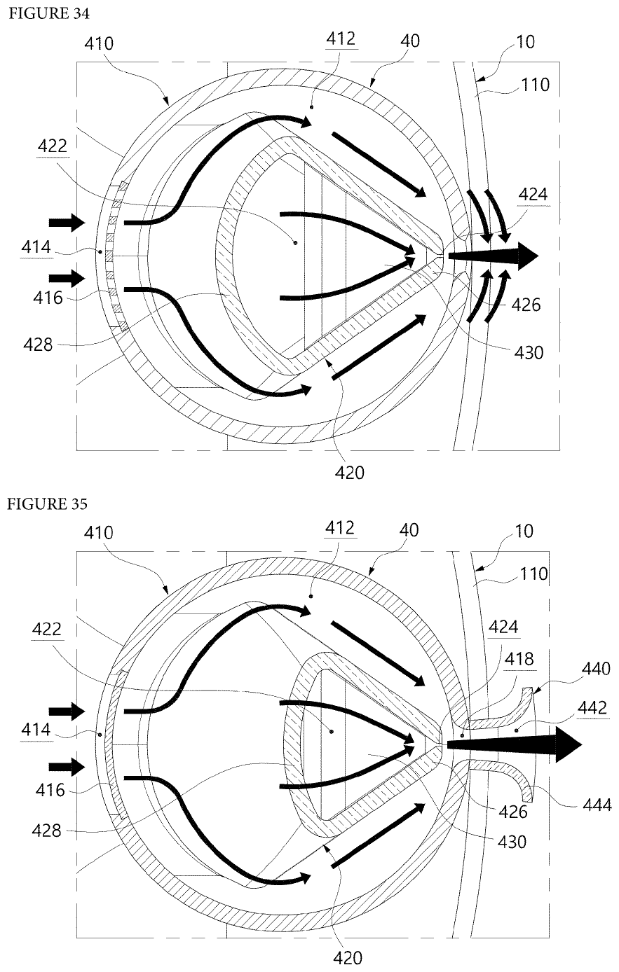

Meanwhile, in a process in which air flowing inside the air flow path 422 exits the flow outlet 424 of the air duct 420 and enters the discharge port 418, air around the air duct 420 may be combined with the air by the Coanda effect, and the combined air may be discharged through the discharge port 418. By this operation, air around the discharge column 40 may be drawn in through the column intake port 414 in the column body 410 and drawn into the column internal space 412. In FIG. 34, this airflow is indicated by arrows. Air drawn into the column internal space 412 may be combined with air flowing from the flow outlet 424 to the discharge port 418 and the combined air may be discharged through the discharge port 418 and delivered to a user.

In the airflow illustrated in FIG. 34, when air is discharged from the discharge port 418 of the column body 410, air around the discharge port 418 may be combined with the air according to the Bernoulli's principle. However, this air is not purified, and thus using the blowing nozzle 440 as in FIG. 35 may prevent the mixing of the air around the discharge column 40, and may send air blown by the blowing nozzle 440 further.

Air may also be blown through the upper discharge column 50 to dry the body, face, head, etc. of a user. Air discharged from the upper discharge column 50 may be drawn in from the outside by the upper air blowing unit 530 in the embodiment shown in FIG. 3 and delivered to the upper air flow path 522 of the upper air duct 520. In the upper air duct 520, the flow cross-sectional area of the upper air flow path 522 may become narrower gradually in a direction away from the upper air blowing unit 530. Accordingly, air discharged through the discharge port 518 of the upper discharge column 50 may be uniformly distributed in the entire section of the discharge port 528 of the upper discharge column 50. The air discharged through the discharge port 518 may include air drawn in by the upper air blowing unit 530 and air around the upper discharge column 50 drawn in through the upper column intake port 514.

The installation angle of the upper discharge column 50 may be adjusted with respect to the discharge column 40. That is, when a user stands in front of the discharge column 40, the upper discharge column 50 may be operated to tilt toward the user. The operation of the upper discharge column 50 may be performed in a predetermined direction with respect to the discharge column 40. That is, the direction of the operation of the upper discharge column 50 may be determined by the first stop surface 612 and the second stop surface 622 of the joint mechanism 60.

Rotation in the direction in which the planar parts 614 and 624 are in contact with each other may occur only until the planar parts 614 and 624 are in contact with each other. No further rotation in that direction may occur. When the planar parts 614 and 624 are in contact with each other, as can be seen in FIG. 17, the inclined part 616 of the first stop surface 612 and the inclined part 626 of the second stop surface 622 may be separated from each other. In this state, the discharge column 40 and the upper discharge column 50 may be arranged in a straight line.

When the upper discharge column 50 is rotated to be inclined with respect to the discharge column 40, the planar parts 614 and 624 may move away from each other, and the inclined parts 616 and 626 may move closer to each other. When the upper discharge column 50 is rotated to maximum inclination thereof, the inclined parts 616 and 626 may be in contact with each other. This state may be seen in FIG. 16.

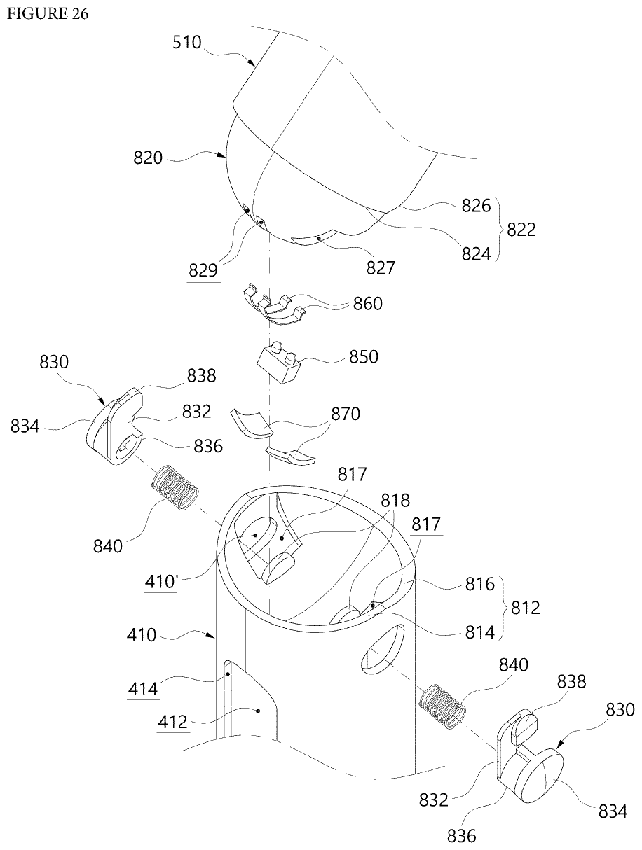

Meanwhile, in the embodiment illustrated in FIG. 16 or FIG. 17, the upper discharge column 50 may be separated from the discharge column 40. This may be achieved by the male joint 610 being removed from the female joint 610. In this way, the upper discharge column 50 may be separated from the discharge column 40 and may be held and used by the hand of a user. In this case, air may be blown from the upper discharge column 50 by the operation of the upper air blowing unit 530. Power for driving the upper air blowing unit 530 may be provided by a battery (not shown) within the upper discharge column 50, and charging of the battery may be provided by Supplying power by electrodes (not shown) (see the electrodes 850 and 860 shown in FIG. 26) that may be present in the joint mechanism 60.

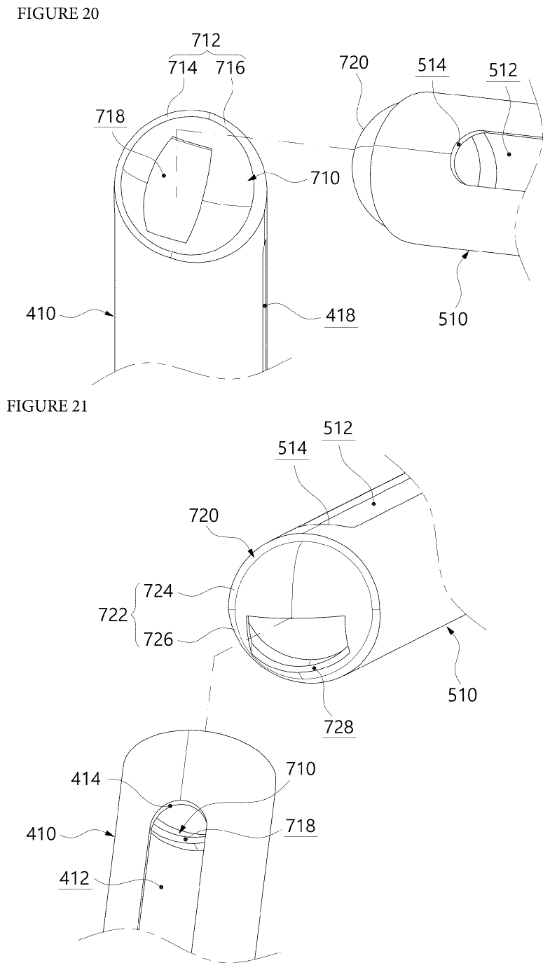

In the embodiment illustrated in FIGS. 19 to 23, the amount of air discharged from the discharge port 518 of the upper discharge column 50 may be adjusted according to an angle at which the upper discharge column 50 is inclined with respect to the discharge column 40. As shown in FIG. 19, when the upper discharge column 50 is erected to be in a straight line with the discharge column 40, the connection duct 730 may be pressed by the edges of the first through-hole 718 and the second through-hole 728, so that the flow cross-sectional area of the connecting flow path 734 at a corresponding location may be decreased, and thus air may not flow. In this case, no air may be discharged through the upper discharge column 50. However, when the upper discharge column 50 is rotated to have a predetermined inclination with respect to the discharge column 40, the flow cross-sectional area of the connecting flow path 734 may increase, allowing air to flow. In FIG. 23, the connecting flow path 734 may not be pressed, so the flow cross-sectional area may be recovered. In this case, a relatively large amount of air may be discharged through the discharge port 518 of the upper discharge column 50.

Next, the operation of the embodiment illustrated in FIGS. 24 to 31 will be described. In this embodiment, the flow of air through the discharge column 40 is the same as in the embodiment described above. However, the upper discharge column 50 does not receive air from the discharge column 40. The upper discharge column 50 may discharge air by the operation of the upper air blowing unit 530 therein.

Additionally, the upper discharge column 50 may be more securely mounted to the discharge column 40. This is because the connector 830 is used. The connector 830 is installed to be supported on the column body 410 of the discharge column 40 by the elastic member 840, so that the upper discharge column 40 may be more easily attached to and detached from the discharge column 40, and the mounted state thereof may be securely maintained. In addition, when the upper discharge column 50 rotates with respect to the discharge column 40, the upper discharge column 50 may rotate around the holding jaw 838 of the connector 830.

FIG. 36 illustrates a state in which the upper discharge column 50 is mounted on the discharge column 40. In this state, in order to separate the upper discharge column 50 from the discharge column 40, a user presses the button 834 in the direction of arrow A. Accordingly, each of the connectors 830 may move in the direction of arrow A. Due to this movement, the holding jaw 838 of the connector 830 may also move in the direction of arrow B and may be released from the holding jaw guide end 828 of the male joint 820. In this case, the upper discharge column 50 may be moved in the direction of arrow C and removed from the discharge column 40.

When the upper discharge column 50 is removed from the discharge column 40, the connector 830 may be moved to its original position by the restoring force of the elastic member 840. In this state, in order for a user to re-attach the upper discharge column 50 to the discharge column 40, the male joint 820 may be inserted into the female joint 810. That is, when the upper discharge column 50 is moved in the opposite direction of arrow C in FIG. 36, the holding jaw guide end 828 may be guided by the inclined surface of the upper end of the holding jaw 838 of the connector 830, thereby elastically deforming the elastic member 840 and moving the connector 830 in the direction of arrow A.

When the guide curved surface 838′ of the holding jaw 838 is seated on the guide curved surface 828′ of the holding jaw guide end 828, the connector 830 may move in the opposite direction of arrow A due to the restoring force of the elastic member 840 and return to its original state. In this case, the upper discharge column 50 may be mounted on the discharge column 40.

In this embodiment, when the upper discharge column 50 is mounted on the discharge column 40, the first electrode 850 and the second electrode 860 may be in contact with each other. Accordingly, when power connection is performed, power may be supplied to the upper air blowing unit 530 in the upper discharge column 50, and may charge the battery.

In the above, even though all components constituting the embodiments according to the present disclosure have been described as being combined or operating in combination as one, the present disclosure is not necessarily limited to these embodiments. That is, within the scope of the purpose of the present disclosure, all of the components may be selectively combined to operate in one or more combinations. In addition, the terms “include,” “constitute,” or “have,” etc., as described above, unless otherwise specifically stated, imply that corresponding components may be present, and therefore should be interpreted to include other components rather than excluding other components. All terms, including technical or scientific terms, unless otherwise defined, have the same meaning as commonly understood by those skilled in the art to which the present disclosure belongs. Commonly used terms, such as terms defined in the dictionary, should be interpreted to be consistent with their contextual meanings in the relevant technology and should not be interpreted in an idealized or overly formal sense unless expressly defined in the present disclosure.

For reference, in the illustrated embodiments, the female joints 610, 710, and 810 are on the discharge column 40, and the male joints 620, 720, and 820 are on the upper discharge column 50. However, the female joints 610, 710, and 810 may be on the upper discharge column 50, and the male joints 620, 720, and 820 may be on the discharge column 40.

1. A stand-type drying device comprising:
a base seated on a floor;
a housing located on the base and having intake holes;
an air blowing unit located inside the housing and allowing air to be drawn in and flow through the intake holes; and
a discharge column having an air flow path formed therein, through which air flowing out of the housing flows, and a discharge port extending vertically, through which air flowing out of the air flow path is discharged to the outside, with the discharge column extending upward from the housing.

2. The drying device of claim 1, further comprising:
an upper discharge column on one side of the discharge column.

3. The drying device of claim 2, wherein the upper discharge column is provided with an upper air blowing unit that draws in external air and causes the air to flow within the upper discharge column and then be discharged.

4. The drying device of claim 2, wherein the discharge column and the upper discharge column are connected to each other by a joint mechanism so that the upper discharge column is rotatable at a predetermined angle relative to the discharge column.

5. The drying device of claim 4, wherein the joint mechanism comprises a female joint having a recessed shape and a male joint having a hemispherical shape, which is inserted into the female joint, provided at corresponding positions of the discharge column and the upper discharge column, respectively.

6. The drying device of claim 1, wherein the air blowing unit comprises a fan duct installed inside the housing and configured to serve as a passage through which air passes, a motor positioned inside the fan duct, and a fan positioned inside the fan duct and configured to be rotated by the motor to form airflow.

7. The drying device of claim 6, wherein an air guide is connected to the fan duct to guide air discharged from the fan duct, wherein the air guide is installed inside the housing and guides air into the discharge column.

8. The drying device of claim 1, wherein an air duct having the air flow path through which an airflow formed by the air blowing unit passes is installed inside the discharge column, and a flow outlet is formed in the air duct in a longitudinal direction thereof to transfer air to the discharge port.

9. The drying device of claim 1, wherein the base comprises a base body having a disc shape, and a rotation center shaft protruding from a center of the base body and serving as a rotation center of the housing.

10. The drying device of claim 9, wherein a connecting curved surface having a predetermined radius of curvature is formed on a portion on which the rotation center shaft and the base body are connected to guide air toward the intake holes in the housing.

11. The drying device of claim 1, wherein the internal space in which the air blowing unit is positioned is formed within the housing, a column installation part in which a lower portion of the discharge column is positioned is formed on one side surface of the housing, and a rotation center hole in which a rotation center shaft of the base is positioned is provided in a lower portion of the housing.

12. The drying device of claim 11, wherein the intake holes through which external air is drawn in by the air blowing unit are formed on the housing adjacent to an edge of the rotation center hole.

13. A stand-type drying device comprising:
a base seated on a floor, with a rotation center shaft protruding from the base;
a housing having a rotation center hole into which the rotation center shaft is inserted and intake holes adjacent to an edge of the rotation center hole;
an air blowing unit located inside the housing and allowing air to be drawn in through the intake holes; and
a discharge column, which is installed on one side surface of the housing, including an air flow path through which air is moved by the air blowing unit and a discharge port extending vertically, through which air of the air flow path is discharged to the outside, with the discharge column extending upward from the housing.

14. The drying device of claim 13, wherein a driving source configured to provide a driving force for rotating the housing is installed inside the rotation center shaft of the base.

15. The drying device of claim 14, wherein the driving force of the driving source is transmitted to the housing rotatably installed on the rotation center shaft through multiple gears.

16. The drying device of claim 13, wherein an outer surface of the rotation center shaft has a step part on which the housing is supported, and the rotation center shaft has a lower outer diameter thereof larger than an upper outer diameter thereof relative to the step part.

17. The drying device of claim 16, wherein a support wall surrounding the intake holes formed to be adjacent to the rotation center hole of the housing is provided, and the air blowing unit is supported on the support wall.

18. The drying device of claim 17, wherein the intake holes provided in the housing are open toward the base, and the base has a connecting curved surface formed as a curved surface having a predetermined radius of curvature toward the intake holes so as to guide surrounding air to the intake holes.

19. The drying device of claim 18, wherein the rotation center shaft is formed at a center of a base body constituting the base, and a curved surface connecting the rotation center shaft with the base body is the connecting curved surface.

20. The drying device of claim 15, wherein a driving window is formed on the rotation center shaft to perform power transmission through the multiple gears.

21-24. (canceled)
